(19) United States
(12) Patent Application Publication
(10) Pub. No.: US 2026/0149877 A1
(43) Pub. Date: May 28, 2026

(54) CAPTURE CONTROL APPARATUS, CAPTURE CONTROL METHOD, AND MULTI-CAMERA SYSTEM

(71) Applicant: CANON KABUSHIKI KAISHA, Tokyo (JP)

(72) Inventor: TAKUYA IWATA, Tokyo (JP)

(21) Appl. No.: 19/396,425

(22) Filed: Nov. 21, 2025

(30) Foreign Application Priority Data
Nov. 28, 2024 (JP) 2024-207704

(51) Int. Cl. H04N 23/66; H04N 23/60; H04N 23/61; H04N 23/695; H04N 23/90

(52) U.S. Cl. CPC H04N 23/66; H04N 23/61; H04N 23/64; H04N 23/695; H04N 23/90

(57) ABSTRACT

Disclosed is a capture control apparatus that controls at least one of a capture direction and an angle of view of each of a plurality of cameras that are connected to the capture control apparatus. The apparatus, in a case of collectively changing configurations of the plurality of cameras, identifies a first camera whose configuration is to be changed first, from among the plurality of cameras and instructs the first camera to change the configuration. The apparatus determines whether or not the instructed change of the configuration of the first camera has been completed and instructs, in response to determining that the instructed change of the configuration of the first camera has been completed, a camera other than the first camera from among the plurality of cameras to change the configuration.

### BACKGROUND

### Field of the Technology

The present disclosure relates to a capture control apparatus, a capture control method, and a multi-camera system, and in particular relates to a technique for controlling image capturing performed using a plurality of image capture apparatuses.

### Description of the Related Art

There are known image capture systems in which a plurality of image capture apparatuses are used (hereinafter, multi-camera system) (Japanese Patent Laid-Open No. 2014-197831). In a conventional multi-camera system, control has been performed in which the moving image that is output from the system is switched between moving images input from a plurality of cameras.

For example, when considering a multi-camera system that uses cameras whose angles of view and capture directions can be remotely controlled, there is a conceivable need to change the capture directions and angles of view of all of the cameras at a specific timing. However, changing capture directions and angles of view takes time.

Thus, when the configurations of all cameras are collectively changed, there can be a period during which all of the cameras are undergoing configuration change. If a moving image that is captured during configuration change is not favorable enough to use in terms of image content or quality, the moving image is interrupted during the period of configuration change. Thus, this may pose a problem, for example, when performing live moving image capturing. A similar problem may also arise when other configurations are changed.

### SUMMARY

In some embodiments of the present disclosure, there is provided a capture control apparatus and a capture control method capable of solving a problem that may arise when collectively changing configurations of a plurality of image capture apparatuses.

According to an embodiment of the present disclosure, there is provided a capture control apparatus that controls at least one of a capture direction and an angle of view of each of a plurality of cameras that are connected to the capture control apparatus, the capture control apparatus comprising: one or more processors that execute a program stored in a memory, wherein the program, when executed by the one or more processors, causes the one or more processors to: in a case of collectively changing configurations of the plurality of cameras, identify a first camera whose configuration is to be changed first, from among the plurality of cameras; instruct the first camera to change the configuration; determine whether or not the instructed change of the configuration of the first camera has been completed; and instruct, in response to determining that the instructed change of the configuration of the first camera has been completed, a camera other than the first camera from among the plurality of cameras to change the configuration.

Features of the present disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of a multi-camera system according to a first embodiment.

FIG. 2 is a block diagram showing configuration examples of apparatuses of the multi-camera system in FIG. 1.

FIGS. 3A and 3B are diagrams showing an example of a configuration screen that is provided by a controller 400 according to the first embodiment.

FIG. 4 is a flowchart related to the operation of the controller 400 according to the first embodiment.

FIGS. 5A and 5B are timing charts of examples of collective change processing of image capture configurations according to the first embodiment.

FIG. 6 is a timing chart of another example of collective change processing of image capture configurations according to the first embodiment.

FIGS. 7A and 7B are flowcharts related to the operations of the controller 400 and the camera 100 according to the first embodiment.

FIG. 8 is a schematic diagram of a multi-camera system according to a second embodiment.

FIG. 9 is a block diagram showing configuration examples of apparatuses of the multi-camera system in FIG. 8.

FIGS. 10A to 10D are flowcharts related to the operations of the apparatuses of the multi-camera system according to the second embodiment.

FIGS. 11A and 11B are schematic diagrams of control corresponding to roles of cameras according to the second embodiment.

FIGS. 12A and 12B are schematic diagrams of control corresponding to roles of cameras according to the second embodiment.

FIG. 13 is a diagram showing relation between operation control and roles that can be assigned to the cameras 100 and 200 according to the second embodiment.

FIGS. 14A to 14C are schematic diagrams of other control corresponding to roles of cameras according to the second embodiment.

FIG. 15 is a flowchart related to the operation of a controller 1400 according to the second embodiment.

FIG. 16 is a diagram for describing pan value calculation according to the second embodiment.

FIG. 17 is a diagram for describing tilt value calculation according to the second embodiment.

FIG. 18 is a diagram showing an example of zoom value mapping between a main camera and a sub camera according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate.

Furthermore, in the attached drawings, the same reference numerals are given to the same or similar configurations, and redundant description thereof is omitted.

### First Embodiment

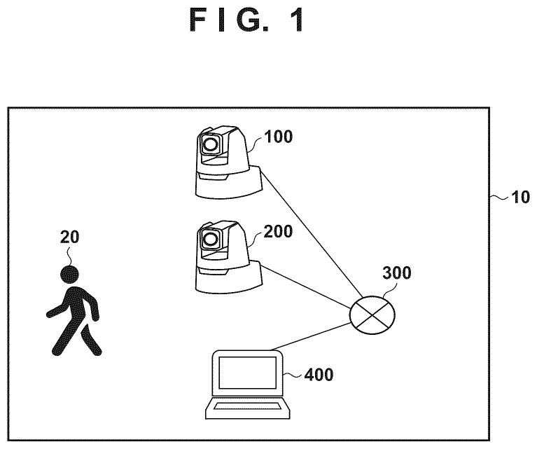

FIG. 1 is a schematic diagram of an overall configuration of a multi-camera system 10 according to a first embodiment. The multi-camera system 10 includes a plurality of cameras 100 and 200 and a controller 400 serving as a capture control apparatus that controls the operations of the cameras 100 and 200. The controller 400 and each of the cameras 100 and 200 are configured to be able to communicate with each other via a network 300. The network 300 may be a portion of the multi-camera system 10 or may be an external network. Note that the controller 400 and each of the cameras 100 and 200 may be directly connected to each other. In this case, the network 300 is not necessary.

In FIG. 1, a case is assumed in which images of a subject 20 are captured using cameras 100 and 200, but the numbers of subjects and cameras are merely examples. The cameras 100 and 200 are PTZ cameras, whose capture directions (pan and tilt angles) and angles of view (zoom) can be remotely controlled from the controller 400.

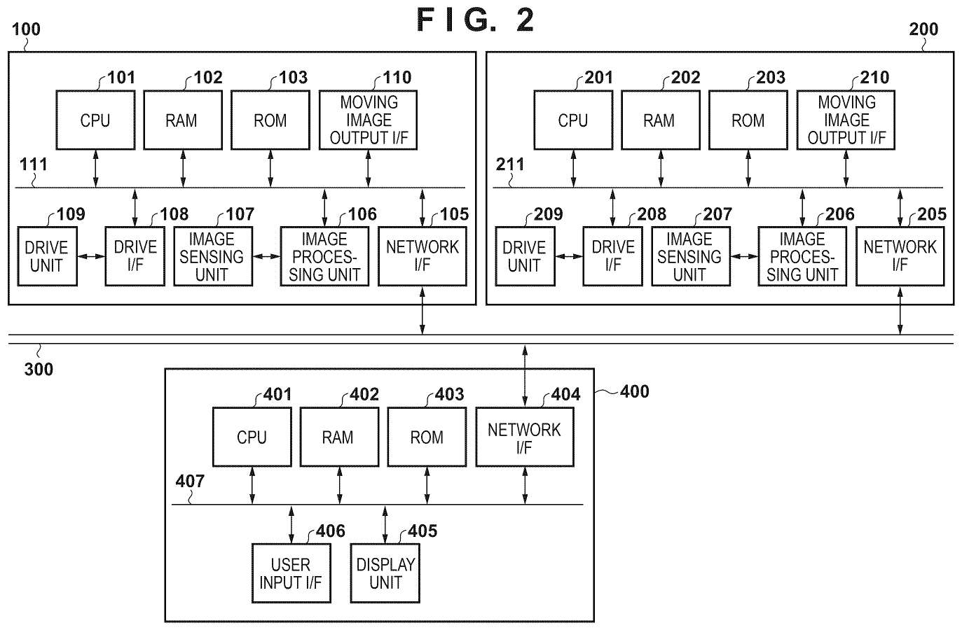

FIG. 2 is a block diagram showing configuration examples of the cameras 100 and 200 and the controller 400. For ease of description, in the present embodiment, the cameras 100 and 200 have the same configuration. Note that FIG. 2 shows only constituent elements required for describing the following operations.

A CPU 101 controls the operations of the constituent elements of the camera 100 and realizes the operation of the camera 100 to be described later, by executing a computer program loaded from a ROM 103 to a RAM 102.

The RAM 102 is a high-speed storage device such as a DRAM. The RAM 102 has an area for storing computer programs and data loaded from the ROM 103, an area for storing images output from an image processing unit 106, and the like. The RAM 102 also has an area for storing various types of information received from the controller 400 via a network interface (I/F) 105, and a work area used by the CPU 101 to execute various types of processing. In this manner, the RAM 102 can provide areas for storing various types of data as appropriate.

The ROM 103 is a rewritable non-volatile storage device such as a semiconductor memory card or an SSD. The ROM 103 stores configuration data of the camera 100, computer programs and data related to the operation of the camera 100, and the like.

The network I/F 105 is an interface for connecting the camera 100 to the network 300. The network I/F 105 can operate in compliance with one or more of known wired and wireless communication standards. The camera 100 can communicate with external apparatuses such as the camera 200 and the controller 400 connected to the network 300, via the network I/F 105. Note that, as described above, the camera 100 may communicate directly with external apparatuses such as the camera 200 and the controller 400 without the intervention of the network 300.

An imaging sensor 107 includes an imaging optical system and an image sensor. The image sensor may be, for example, a known CCD or CMOS color image sensor having a Bayer array color filter of primary colors. The image sensor includes a pixel array in which a plurality of pixels are two-dimensionally arranged and peripheral circuitry for reading out signals from respective pixels. Each pixel stores a charge corresponding to the amount of incident light through photoelectric conversion. By reading out, from respective pixels, signals each having a voltage corresponding to the amount of charge stored during an exposure period, a pixel signal group (analog image signals) representing a subject image formed on an image capture plane is obtained.

The image processing unit 106 applies predetermined signal processing and image processing to analog image signals output from the image sensing unit 107, to generate signals and image data in accordance with an application, and obtain and/or generate various types of information.

Examples of the processing that is applied by the image processing unit 106 may include pre-processing, color interpolation processing, correction processing, detection processing, data processing, evaluation value calculation processing, and special effect processing.

The pre-processing may include A/D conversion, signal amplification, reference level adjustment, and defective pixel correction.

The color interpolation processing is processing that is performed in a case where a color filter is provided in the image sensing unit 107, and is for interpolating the values of color components that are not included in individual pieces of pixel data constituting image data. The color interpolation processing is also referred to as demosaicing processing.

The correction processing may include processing such as white balance adjustment, gradation correction, correction of image deterioration caused by optical aberrations of the imaging optical system (image restoration), correction of the effect of peripheral light falloff of the imaging optical system, and color correction.

The data processing may include processing such as region cropping (trimming), composition, scaling, encoding and decoding, and header information generation (data file generation). Generation of moving image signals to be output to the outside and generation of moving image data to be recorded in the ROM 103 are also included in the data processing.

The evaluation value calculation processing may include processing such as generation of signals and evaluation values to be used for automatic focus detection (AF), and generation of evaluation values to be used for automatic exposure control (AE). The CPU 101 executes AF and AE.

The special effect processing may include processing such as adding a blur effect, changing color tone, and relighting.

Note that these are examples of processing that can be applied by the image processing unit 106, and the processing that is applied by the image processing unit 106 is not limited thereto.

The image processing unit 106 outputs obtained or generated information and data to the CPU 101, the RAM 102, or the like in accordance with an application.

Note that types of processing and configurations applied by the image processing unit 106 can be controlled by transmitting a command from the controller 400 to the camera 100. In addition, the image processing unit 106 may perform the above-described processing in accordance with a command received from the controller 400.

A drive I/F 108 is a communication interface between the CPU 101 and a drive unit 109. The drive unit 109 includes a drive mechanism for changing the capture direction and angle of view of the camera 100, and a drive source such as a motor. Specifically, the drive unit 109 is capable of independently controlling the horizontal (pan) angle and vertical (tilt) angle of the optical axis of the imaging optical system of the camera 100. The drive unit 109 is also capable of driving a lens group (zoom lens) for changing the angle of view of the imaging optical system. Note that it suffices for the drive unit 109 to be capable of controlling at least the pan and tilt angles, and/or the angle of view (zoom value).

Accordingly, by transmitting a command for controlling pan, tilt, and zoom from the CPU 101 to the drive unit 109 via the drive I/F 108, the capture direction and angle of view of the camera 100 can be controlled.

A moving image output I/F 110 is an interface for outputting, to the outside, moving image signals generated by the image processing unit 106. The moving image output I/F 110 may be an interface that complies with standards such as serial digital interface (SDI) and high-definition multimedia interface (HDMI) (registered trademark).

The CPU 101, the RAM 102, the ROM 103, the network I/F 105, the image processing unit 106, the drive I/F 108, and the moving image output I/F 110, which have been described above, are connected to a system bus 111.

The camera 200 includes a CPU 201, a RAM 202, a ROM 203, a moving image output I/F 205, an image processing unit 206, an image sensing unit 207, and a moving image output I/F 210. Details of the constituent elements of the camera 200 are the same as those of the constituent elements of the camera 100 that have the same names.

The controller 400 may be a general-purpose computer device (such as a personal computer) that executes a capture control application. The controller 400 receives moving image signals transmitted from the cameras 100 and 200 and transmits control signals (commands) to the cameras 100 and 200, via the network 300.

For example, based on an operation accepted through a user input I/F 406, the controller 400 can transmit, to the cameras 100 and 200, a command designating one or more of a pan angle, a tilt angle, and a zoom value. In addition, based on an operation accepted through the user input I/F 406, the controller 400 can transmit, to the cameras 100 and 200, a command designating an image capture size of a subject to be tracked. The image capture size may be, for example, the size of a rectangle (the number of pixels in a vertical, horizontal, or diagonal direction) circumscribing a region of the subject to be tracked in an image.

As described above, by performing an operation on the user input I/F 406, the user can give an instruction to set image capture configurations of the cameras 100 and 200. Examples of image capture configurations include a pan value, a tilt value, a zoom value, a focus value, and an image quality mode, and, in a case of tracking a subject and capturing an image of the subject, an image capture target, an image capture size of the target, an image capture composition of the target, and a tracking speed are included. Note that one or more of the image capture configurations may be automatically designated by the controller 400.

A CPU 401 controls the operations of the constituent elements of the controller 400 and realizes the operation of the controller 400 to be described later, by executing a computer program loaded from a ROM 403 to a RAM 402.

The RAM 402 is a high-speed storage device such as a DRAM. The RAM 402 has an area for storing computer programs and data loaded from the ROM 403, and an area for storing moving image signals received from the cameras 100 and 200 via a network I/F 404. The RAM 402 also has a work area used by the CPU 401 to execute various types of processing. In this manner, the RAM 402 can provide areas for storing various types of data as appropriate.

The ROM 403 is a rewritable non-volatile storage device such as a semiconductor memory card or an SSD. The ROM 403 stores configuration data of the controller 400, computer programs and data related to the operation of the controller 400, and the like. The above capture control application is also stored in the ROM 403.

The network I/F 404 is an interface for connecting the controller 400 to the network 300. The network I/F 404 can operate in compliance with one or more of known wired and wireless communication standards. The controller 400 can communicate with external apparatuses such as the cameras 100 and 200 connected to the network 300, via the network I/F 404. Note that, as described above, the controller 400 may communicate directly with external apparatuses such as the cameras 100 and 200 without the intervention of the network 300.

A display unit 405 may be a liquid crystal display, an organic EL display, or the like. The display unit 405 displays screens provided by moving image signals received from the cameras 100 and 200, a program (an OS, the capture control application, etc.) running on the controller 400, and the like.

In the following description, it is assumed that the display unit 405 is a touch display. Note that, in FIG. 2, the display unit 405 is incorporated into the controller 400, but the display unit 405 may be configured to be connected to the controller 400 as an external apparatus.

The user input I/F 406 is an input device for the user to input instructions to the controller 400. The user input I/F 406 includes, for example, one or more of a mouse, a keyboard, buttons, a dial, a joystick, and a touch panel.

The CPU 401, the RAM 402, the ROM 403, the network I/F 404, the display unit 405, and the user input I/F 406 are connected to a system bus 407.

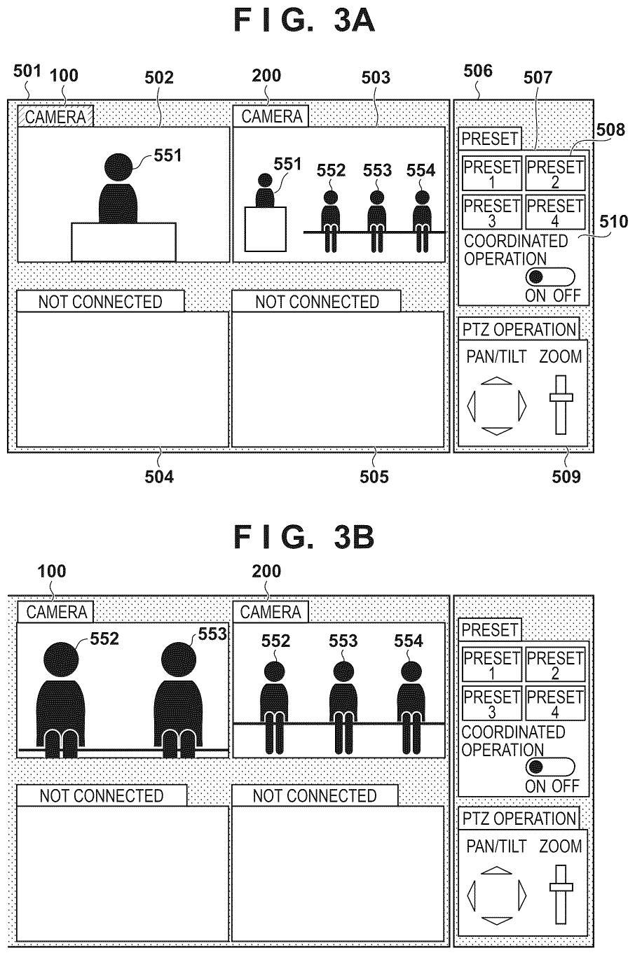

FIGS. 3A and 3B are diagrams showing examples of configuration screens provided by the capture control application that runs on the controller 400. Note that the configuration screens shown in FIGS. 3A and 3B are examples, and the layout and display items may be changed.

Each of the configuration screens includes a moving image region 501 and an operation region 506. The moving image region 501 is a region for individually displaying moving images received from cameras controlled by the controller 400. In the examples shown in FIGS. 3A and 3B, the moving image region 501 includes four small regions 502 to 505, and is configured such that moving images from up to four cameras can be displayed. In the present embodiment, since the number of cameras that are controlled by the controller 400 is two, a moving image received from the camera 100 is displayed in the small region 502, and a moving image received from the camera 200 is displayed in the small region 503. A label region is provided on the upper-left side of each small region to display the name of the camera capturing the moving image. Here, for convenience, “camera 100” and “camera 200” are displayed, but, in practice, a model name of each camera, a name assigned by the user, or the like is displayed.

When changing image capture configurations of a camera, the user first selects a camera whose image capture configurations are to be changed, from the moving image region 501. The CPU 401 selects a camera in accordance with a touched small region or label region in the moving image region 501. The CPU 401 may provide feedback to the user that the selection has been accepted by making the display of the small region and label region for which the touch operation has been performed, different from the display of the other small regions. In FIGS. 3A and 3B, based on a touch operation detected on the small region 502, the CPU 401 thickens the frame of the small region 502 and inverts the corresponding label region.

When a touch operation is detected on a small region or label region corresponding to a selected camera, the CPU 401 sets the camera to a non-selected state and returns the display to that of the non-selected state. Note that the CPU 401 permits selection of a plurality of cameras selected by performing an operation on the moving image region 501.

The operation region 506 is a region for designating image capture configurations of a selected camera. The operation region 506 includes small regions corresponding to items that are designated. Here, as one example, the operation region 506 includes two small regions 507 and 509, but the number of small regions is not limited to two. Note that, although a small region 510 does not directly designate image capture configurations, it is a region for setting a designation method, and is thus included in the operation region 506.

The small region 507 is a region for designating presets. A preset is a set of values set in advance for a plurality of configuration items. Here, it is assumed that a preset is a combination of a specific pan angle, tilt angle, and zoom value, but the number and types of items that can be preset may be changed. For example, a focus position within a screen or a driving speed of the drive unit 109 and the like may be included as preset items. In the examples shown in FIGS. 3A and 3B, a case is illustrated in which four presets can be registered, and the small region 507 includes preset buttons 508 corresponding to the individual presets, but the number of presets that can be registered is not limited to four.

In the present embodiment, configured values of cameras can be registered in a single preset. That is, configured values for the camera 100 and configured values for the camera 200 can be independently registered as a “preset 1”. Accordingly, by simply designating the “preset 1”, individual configured values can be designated for both the cameras 100 and 200 through a single operation.

When a touch operation on any of the preset buttons 508 is detected, the CPU 401 reads out a preset corresponding to the preset button on which the touch operation was performed, from, for example, the ROM 403. The CPU 401 then extracts configured values from the preset for the selected cameras, and transmits, via the network I/F 404, a command in which items and configured values are designated. Details will be described below.

The small region 509 is a region for manually designating a capture direction and angle of view of a camera, and includes user interface (UI) elements for changing the pan angle and tilt angle, and a UI element for changing the angle of view (zoom value). The UI elements for changing the pan angle and the tilt angle includes buttons corresponding to upward, downward, rightward, and leftward directions, respectively. The buttons for the upward and downward directions constitute the UI element for changing the tilt angle, and the buttons for the rightward and leftward directions constitute the UI element for changing the pan angle. For example, a single operation on a button corresponds to an instruction to rotate the camera by a unit angle in the corresponding direction.

The UI element for changing the zoom value has a vertically movable slider UI. For example, moving the slider upward corresponds to zooming in, and moving the slider downward corresponds to zooming out. Note that the slider position indicates the current zoom value (angle of view).

When an operation on one of these UI elements is detected, the CPU 401 generates a command corresponding to the detected operation, and transmits the command to the selected camera via the network I/F 404.

The small region 510 is a switch for designating whether or not to set a collective change method to “coordinated” (i.e., whether or not to perform a change operation in coordination) when collectively changing configurations of a plurality of cameras. The small region 510 will be described in detail later.

As an example, an operation will be described, which is performed when the user collectively changes the capture directions and angles of view of the cameras 100 and 200 from a state of capturing the moving images shown in FIG. 3A to a state of capturing the moving images shown in FIG. 3B, by designating a preset.

First, the user registers a preset in advance. That is, the user registers a capture direction and an angle of view for the camera 100 to capture the moving image shown in FIG. 3B, as Preset 1 of Camera 1. The user also registers, in advance, a capture direction and an angle of view for the camera 200 to capture the moving image shown in FIG. 3B, as Preset 1 of Camera 2. Presets are registered through another configuration screen provided by the capture control application, and the registered presets are stored in the ROM 403.

Thereafter, in the state shown in FIG. 3A, the user selects the cameras 100 and 200 by performing an operation on the small region 502 corresponding to the camera 100 and the small region 503 corresponding to the camera 200. In the state where the cameras 100 and 200 are selected, the user performs an operation on the “Preset 1” button of the small region 507.

Accordingly, the controller 400 performs control such that the cameras 100 and 200 are set to the capture directions and angles of view registered as Preset 1. Note that, at this time, as will be described later, the controller 400 performs a configuration change operation in accordance with the collective change method (“normal” or “coordinated”) designated in the small region 510. In this manner, the user can collectively change image capture configurations of the cameras 100 and 200. Note that, here, although a case has been described where the user changes image capture configurations by performing an operation on a preset button, the controller 400 may automatically change the configurations when predetermined conditions are satisfied. For example, when a specific time has elapsed from a reference time, the controller 400 can automatically and collectively change image capture configurations of the cameras 100 and 200.

The operations of the cameras 100 and 200 and the controller 400 for realizing the above-described collective change of image capture configurations will be described.

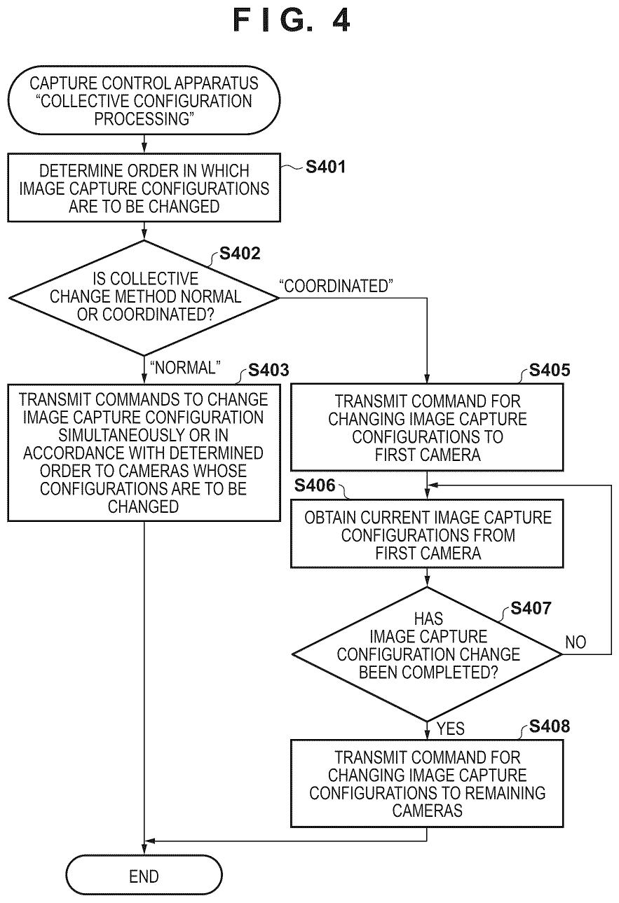

FIG. 4 is a flowchart related to the operation of the controller 400 in a case of collectively changing configurations of a plurality of cameras. The operation to be described below is performed by the CPU 401 executing the capture control application.

Note that the case of collectively changing configurations of a plurality of cameras refers, for example, to a case where there are a plurality of selected cameras when an instruction to change configurations (operation on one of the preset buttons 508) is detected on the configuration screens shown in FIGS. 3A and 3B. When an instruction to change configurations is detected and there are a plurality of selected cameras, the CPU 401 recognizes the instruction as a collective change instruction. Note that an example of a collective change instruction has been described here, and an instruction to change configurations of a plurality of cameras may be given by another method.

On the other hand, if there is one selected camera when an instruction to change configurations is detected, the CPU 401 transmits a command designating new configurations, to the selected camera. In addition, if there is no selected camera when an instruction to change configurations is detected, the CPU 401 ignores the instruction to change configurations and displays a message “please select a camera”, for example.

Here, as an example, the processing in the flowchart shown in FIG. 4 is executed by an operation on one of the preset buttons 508 being detected in a state where the cameras 100 and 200 are selected. The CPU 401 stores the type of preset button on which the operation was performed and the state of the region 510 (whether “coordinated” is on or not), for example, in the RAM 402.

In S401, the CPU 401 determines the order in which the configurations of cameras whose configurations are to be changed (the cameras 100 and 200) are changed. Any method may be adopted to determine the order, and, for example, the order may be determined by selecting items through the configuration screens in FIGS. 3A and 3B, or the order may be the order in which the cameras established connection with the controller 400. Here, as an example, it is assumed that the CPU 401 has determined that the image capture configurations of the camera 100 and the camera 200 are to be changed in the stated order.

Next, in step S402, the CPU 401 determines whether the collective change method is “normal” or “coordinated”, and executes step S405 if the collective change method is “coordinated”, and executes step S403 if the collective change method is “normal”. The CPU 401 determines that the collective change method is “coordinated” if the state of the region 510 when the collective change instruction was detected is ON, and that the collective change method is “normal” if the state is OFF.

First, the case where the collective change method is “normal” will be described. In step S403, the CPU 401 transmits, via the network I/F 404, commands for changing the image capture configurations of the cameras whose image capture configurations are to be changed, either simultaneously or sequentially starting from the camera earliest in the order. Note that, in the case where the collective change method is “normal” and the commands are not transmitted simultaneously, the transmission order does not necessarily need to follow the order determined in step S401.

As described above, the CPU 401 extracts, from the image capture configurations of the cameras included in the preset designated by the user, the image capture configurations of the cameras 100 and 200 whose configurations are to be changed. The CPU 401 then generates a command to be transmitted to the camera 100 and a command to be transmitted to the camera 200, based on the extracted image capture configurations.

Thereafter, the CPU 401 transmits the generated commands to the respective cameras via the network I/F 404. Upon receiving the command via the network I/F 105, the CPU 101 of the camera 100 changes the image capture configurations thereof in accordance with the command. For example, when target values of a pan angle and a tilt angle are designated in the command, the CPU 101 determines the difference between the current pan angle and the target value and the difference between the current tilt angle and the target value (drive amounts). The CPU 101 then generates a command for driving the drive unit 109 in a direction corresponding to the signs of the differences by an angle corresponding to the magnitudes of the differences, and transmits the command to the drive unit 109 via the drive I/F 108. Accordingly, the capture direction of the camera 100 is changed. Note that the CPU 101 may notify the device that has transmitted the command (here, the controller 400) that an operation (here, an operation of changing the image capture configurations) corresponding to the received command has been completed.

Note that, in a case where one or more specific capture directions are registered in the ROM 103 in advance, it suffices for a command that is transmitted from the controller 400 to the camera to include identification information (such as a number) indicating one of the specific capture directions. Since the operation of the CPU 201 of the camera 200 is similar to that of the CPU 101, a description thereof is omitted.

When the collective change method is “normal”, commands to change image capture configurations can be transmitted to the target cameras at any timing, such as simultaneously in order to permit a plurality of cameras to undergo configuration change simultaneously. Thus, even when there are a large number of target cameras, there are advantages that configurations can be collectively made, and in addition, the time required for changing the configurations is shortened.

Next, a case will be described in which the collective change method is “coordinated”. In step S405, the CPU 401 generates a command to change the image capture configurations of the first camera in the order determined in step S401. The CPU 401 then transmits the generated command to the target camera via the network I/F 404.

In step S406, the CPU 401 obtains the current image capture configurations from the first camera.

In step S407, the CPU 401 determines whether or not the change of the image capture configurations of the camera to which the command was transmitted in step S405 has been completed. Specifically, the CPU 401 determines whether or not the configured values obtained in step S406 reflect the designated configuration change.

For example, when a command designating a pan angle and a tilt angle is transmitted in step S405, the CPU 401 obtains the current pan angle and tilt angle from the camera. The CPU 401 then determines that the change of the image capture configurations has been completed if the obtained current pan angle and tilt angle match the pan angle and tilt angle designated in step S405, and determines that the change has not been completed if not.

Note that, even if the current configured values do not match the instructed configured values, it may be determined that the image capture configurations have been changed if specific conditions are satisfied. For example, if the differences from instructed configured values are less than or equal to thresholds, it can be determined that the configurations have been changed. This is because, if the current configured values are close to the instructed configured values, it is highly likely that a moving image close to a desired moving image will be obtained.

When changing the configurations of a plurality of items, the CPU 401 can determine, in step S407, that the change of the image capture configurations has been completed if one or more of a plurality of items match the designated configured values, or if the differences from the designated values for all of the plurality of items are less than or equal to thresholds (for example, predetermined ratios).

In addition, with respect to a capture direction (at least one of a pan angle and a tilt angle), the CPU 401 may determine that the change of the configurations has been completed if a designated capture direction is included in the angle of view. The CPU 401 can determine that the designated capture direction is included in the angle of view when all of Expressions 1 to 4 below are satisfied, for example.

$$P a {n}_{t a r g e t} > P a {n}_{cur} - {Zoom\_h}_{cur} \qquad ( Expression 1 )$$

$${Pa n}_{t a r g e t} < P a {n}_{cur} + {Zoom\_h}_{cur} \qquad ( Expression 2 )$$

$$Til {t}_{t a r g e t} > T i l {t}_{cur} - {Zoom\_v}_{cur} \qquad ( Expression 3 )$$

$$Til {t}_{t a r g e t} < T i l {t}_{cur} + {Zoom\_v}_{cur} \qquad ( Expression 4 )$$

In Expressions 1 to 4, Pan_{target} and Tilt_{target} represent the changed pan angle and tilt angle, respectively. In addition, Pan_{cur} and Tilt_{cur} represent the current pan angle and tilt angle of the camera whose configurations are to be changed. Zoom_h_{cur} represents the magnitude of the pan angle corresponding to one-half of the current horizontal angle of view of the camera whose configurations are to be changed, and Zoom_V_{cur} represents the magnitude of the tilt angle corresponding to one-half of the current vertical angle of view of the camera whose configurations are to be changed. Therefore, the current captured area is defined by the range of an_{cur}±Zoom_h_{cur} in the horizontal direction and Tilt_{cur}±Zoom_h_{cur} in the vertical direction.

In addition, instead of determining whether or not the differences between the designated values and the current values are less than or equal to the thresholds, determination may be performed on whether or not the change amounts of the configured values have decreased. This is because, in a configuration in which a member is mechanically driven to a target position, as with the drive unit 109 of the camera 100, control is usually performed such that the moving speed of the member is reduced slightly before reaching the target position and becomes zero at the target position. Therefore, when the moving speed (i.e., a change amount of position or angle) decreases, it is considered that the member is approaching the target position.

Thus, the CPU 401 calculates amounts of change for the respective items (pan angle, tilt angle, and zoom lens position) from a time series of current configured values obtained in the loop of S406 and S407. The CPU 401 can then determine that the change of the image capture configurations has been completed for an item whose amount of change (moving speed) has decreased.

In addition, in order to simplify the determination processing, the CPU 401 may determine that the change of image capture configurations has been completed if the elapsed time from when a command to change the image capture configurations has exceeded a predetermined time. It is assumed that the predetermined time is predetermined in advance, for example, in accordance with an item of image capture configurations to be changed. The predetermined time can be set to be long (for example, four seconds), for example, for an item whose change involves the operation of the drive unit 109, such as a pan angle, a tilt angle, or a zoom value. In addition, the predetermined time can be set to be short (for example, one second), for example, for an item whose change does not involve the operation of the drive unit 109, such as configured values stored in the ROM.

In addition, for an item whose change involves the operation of the drive unit 109, the length of the predetermined time may vary in accordance with an amount of change. The CPU 401 obtains the current value, for example, before executing step S405, and calculates the difference between the obtained current value and the value designated in a command to be transmitted in step S405 (amount of change). Then, for example, in a case of a pan angle or a tilt angle, the CPU 401 may divide a range of 0 to 180° into six equal ranges corresponding to amounts of change of angle (absolute values), and thereby define six levels of predetermined time that gradually increase with the ranges. Alternatively, the CPU 401 may divide the amount of change by the average movement speed of the drive unit to estimate the time required to change the configurations, and use the estimated time as the predetermined time. To change a plurality of items, the CPU 401 calculates estimated times for the respective items and uses the longest estimated time as the predetermined time. In a case where a movement speed is designated in a command, the CPU 401 calculates an estimated time using the movement speed designated in the command.

Note that the CPU 401 may change the order determined in S401 to an ascending order of estimated times calculated in this manner before executing S405. Accordingly, the controller 400 can preferentially change the image capture configurations of a camera whose image capture configurations can be changed in a shorter time, and can shorten the time until when a moving image captured in accordance with the changed configurations is obtained.

In S408, the CPU 401 generates a command to change image capture configurations of each of the remaining (second and subsequent) cameras. The CPU 401 then transmits the generated commands to the respective cameras via the network I/F 404, either simultaneously or in the order determined in S401 (or in the ascending order of the estimated times described above). The CPU 401 then ends the collective configuration processing. For cameras other than those to which the commands were transmitted in S405, it is not necessary to determine whether or not the change of the configurations has been completed.

When the collective change method is “coordinated”, until it is determined that change of the image capture configurations of at least one of the plurality of cameras whose configurations are to be collectively changed has been completed, the CPU 401 does not transmit commands to the remaining cameras. Thus, there is no period during which all of the plurality of cameras whose configurations are to be collectively changed are undergoing configuration change. Even in a case where, when the image capture configurations of at least one camera have been changed, there is a period during which all of the remaining cameras are undergoing change of image capture configurations, a moving image captured in accordance with the changed configurations can still be obtained.

Note that, here, when the default setting of the small region 510 for setting the collective change method is “normal”, and the “coordinated” method is not explicitly set, collective change processing is executed using the “normal” method. However, conversely, the default setting of the small region 510 may be “coordinated”.

Note that, when the number of cameras whose image capture configurations are to be collectively changed is three or more, the number of cameras for which check is performed on whether or not change of image capture configurations has been completed may be two or more. In this case, the CPU 401 executes processing of steps S405 to S407 for each of the cameras for which check is performed on whether or not change of image capture configurations has been completed, and then executes step S408. If the number of cameras for which check is performed on whether or not change of image capture configurations has been completed is increased, the time required for collectively changing the image capture configurations increases, and thus the number of such cameras can be set such that the total of estimated times described above does not exceed a threshold. In addition, in order to ensure a moving image that is captured from a different capture direction based on changed configurations, the number of cameras can be set to two, namely first and second cameras.

In addition, among cameras whose image capture configurations are to be collectively changed, the number of cameras for which check is performed on whether or not change of image capture configurations has been completed and the number of cameras for which check is not performed on whether or not change of image capture configurations has been completed may be the same (about the same if the total number of cameras is an odd number). For example, when the number of cameras whose image capture configurations are to be collectively changed is six, check is performed on whether or not change of the image capture configurations of half of the cameras (three cameras) has been completed, while check is not performed on whether or not change of the image capture configurations of the remaining three cameras has been completed. Accordingly, it is possible to eliminate a bias in the number of cameras between cameras for which change of configurations has been completed and that are to capture moving images with content and quality desired by the user, and the cameras for which priority is given to reducing the time required for changing configurations.

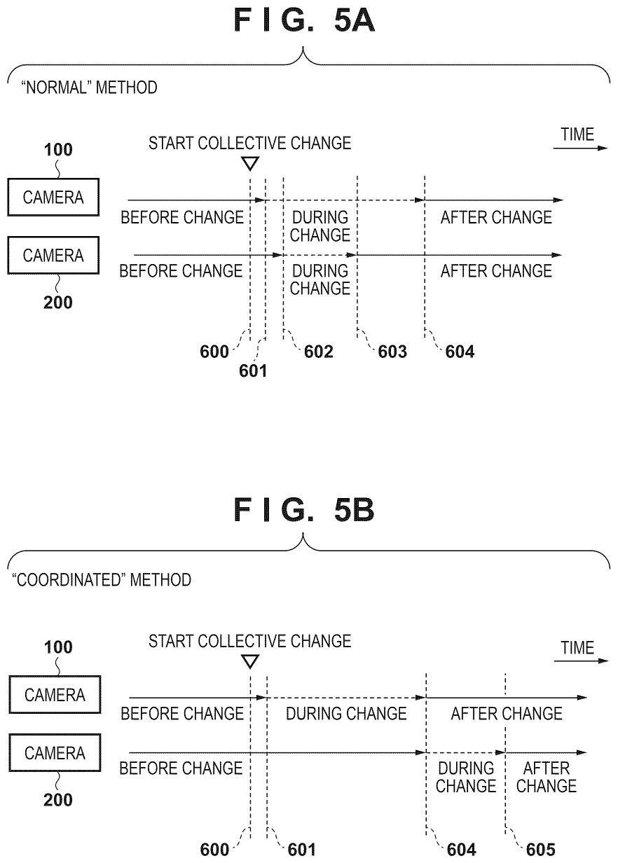

FIGS. 5A and 5B are timing charts for collectively changing image capture configurations of the cameras 100 and 200 through the processing of the flowchart shown in FIG. 4. FIG. 5A is a timing chart in a case where the collective change method is “normal”, and FIG. 5B is a timing chart in a case where the collective change method is “coordinated”. The same reference numerals are assigned to times common to the two methods.

Here, it is assumed that the CPU 401 started a collective change operation at time 600. As described above, the collective change operation can be started in response to detection of an operation on a preset button 508, or in response to detection by the CPU 401 that a predetermined condition other than a user operation, such as an elapsed time from the start of image capturing, has been satisfied.

At time 601, a command to change image capture configurations is transmitted from the controller 400 to the camera 100. This corresponds to the first execution of step S403 in FIG. 4 or execution of step S405. Here, when the collective change method is “normal”, commands are transmitted in the order determined in S401. The camera 100 that has received the command starts to change the image capture configurations in accordance with the command.

At time 602 in FIG. 5A, a command to change image capture configurations is transmitted from the controller 400 to the camera 200. This corresponds to second command transmission of step S403 in FIG. 4. The camera 200 that has received the command starts to change the image capture configurations in accordance with the command. The interval between times 601 and 602 is determined in advance.

It is assumed that change of the image capture configurations of the camera 200 is completed at time 603 in FIG. 5A. At time 603, change of the configurations of the camera 100 has not been completed. This is because the time required for changing image capture configurations varies in accordance with items of configuration change, an amount of change, and the like. For example, changing an item whose change involves the operation of the drive unit 109 takes longer than changing an item whose change does not involve the operation of the drive unit 109. In addition, in a case of changing an item whose change involves the operation of the drive unit 109, the larger the amount of change is, the longer the time required for changing the image capture configurations becomes.

It is assumed that change of the image capture configurations of the camera 100 is completed at time 604. If the collective change method is “normal”, change of the image capture configurations of the cameras 100 and 200 is completed at time 604. On the other hand, if the collective change method is “coordinated”, no command has been transmitted to the camera 200 at time 604 since the camera 100 is the first camera. When the CPU 401 executes step S407 at time 604 or later, it is determined that change of the image capture configurations was completed, and step S408 is executed, whereby a command to change the image capture configurations is transmitted to the camera 200.

Change of the image capture configurations of the camera 200 is completed at time 605 in FIG. 5B.

As described above, if the collective change method is “normal”, change of the image capture configurations of the cameras 100 and 200 is completed at time 604, and thus the image capture configurations of all the cameras can be changed in a short period compared with the case where the collective change method is “coordinated”.

On the other hand, if the collective change method is “normal”, the period from time 602 to time 603 is a period during which both the camera 100 and the camera 200 are undergoing change of configurations. Thus, there is the possibility that moving images obtained from the cameras 100 and 200 during the period from time 602 to time 603 do not have content and quality desired by the user.

If the collective change method is “coordinated”, the period from time 601 to time 604, during which the image capture configurations of the camera 100 are being changed, and the period from time 604 to time 605, during which the image capture configurations of the camera 200 are being changed, do not overlap each other. For this reason, it is ensured that, in all periods, a moving image having content and quality desired by the user is obtained from one of the cameras.

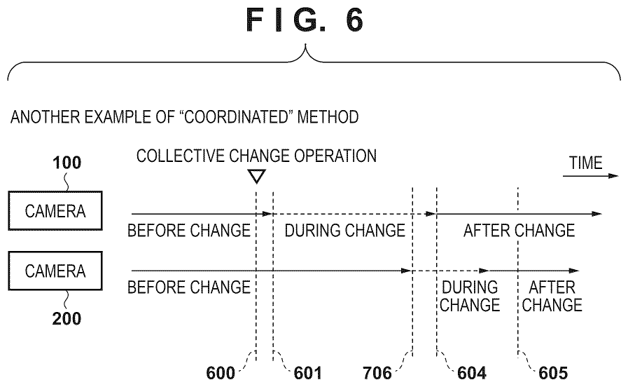

Note that, as described as an example of determination processing of step S407 in FIG. 4, in a case of starting change of the image capture configurations of the camera 200 without checking change of image capture configurations of the camera 100, the time chart in FIG. 5B can be changed to what is shown in FIG. 6, for example. In FIG. 6, the same reference numerals are assigned to times common to those in FIG. 5B.

In the time chart shown in FIG. 6, at time 706, which is earlier than time 604 when change of the image capture configurations of the camera 100 is completed in practice, the controller 400 transmits, to the camera 200, a command to change the image capture configurations. As a result, the period from time 706 to time 604 is a period during which the configurations of both the camera 100 and the camera 200 are being changed. However, this period is sufficiently shorter than in the case where the collective change method is “normal”.

Note that, in the description given with reference to the flowchart in FIG. 4, the controller 400 determines whether or not change of image capture configurations that is based on a transmitted command has been completed. However, a camera that has received the command may determine whether or not change of image capture configurations that is based on the command has been completed, and notify the controller 400 of the completion. In this case, the CPU 401 does not need to execute step S406 in FIG. 4. Then, it suffices for the CPU 401 to determine in step S407 whether or not a notification that configuration change has been completed has been received from the camera to which the command to change the image capture configurations was transmitted in step S405, via the network I/F 404.

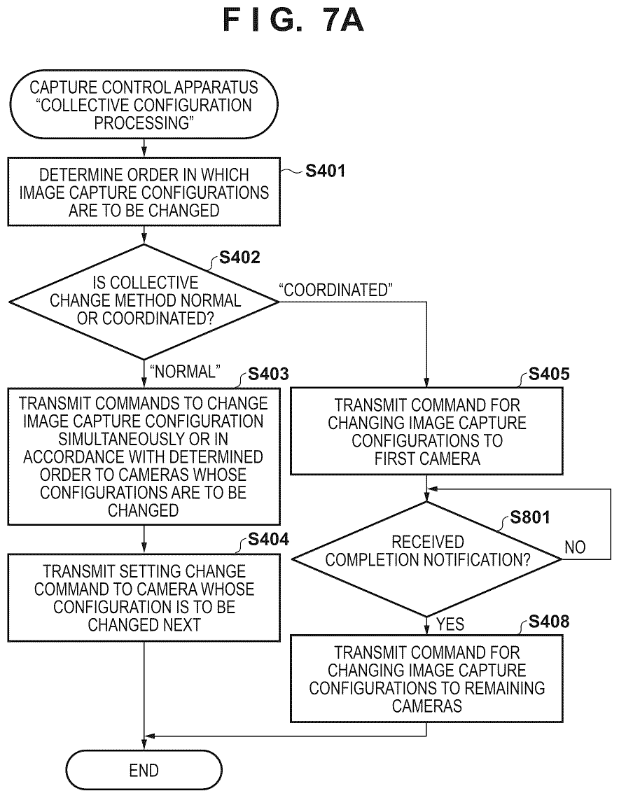

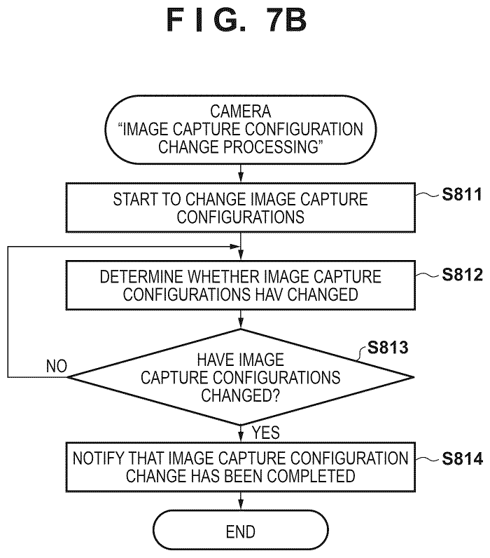

Specific operations of the controller 400 and the camera 100 will be described with reference to the flowcharts shown in FIGS. 7A and 7B. Note that, in FIG. 7A, the same reference numerals are assigned to steps for performing the same processing as FIG. 4, and a description thereof is omitted.

FIG. 7A is a flowchart showing the operation of the controller 400 (the CPU 401), and FIG. 7B is a flowchart showing operation of the camera 100 (the CPU 101). Here, a case will be described in which the camera 100 receives a command, but also in a case where the camera 200 receives a command, the CPU 201 executes similar processing.

The operation of the controller 400 if the collective change method is “normal” is similar to that in FIG. 4, and thus a description thereof is omitted.

If the collective change method is “coordinated”, the CPU 401 transmits a command to the camera 100 in step S405, and then determines, in step S801, whether or not a “change completion notification of image capture configurations” to be described later has been received from the camera 100 via the network I/F 404. If determining that the change completion notification has been received, the CPU 401 executes step S408, and otherwise repeatedly executes step S801. Accordingly, until change of image capture configurations of the camera 100 is completed, the controller 400 does not transmit a command to change image capture configurations to the camera 200.

In step S811 in FIG. 7B, the CPU 101 of the camera 100 starts to change the image capture configurations based on the command received via the network I/F 105. For example, when target pan and tilt angles are set in the received command, the CPU 101 generates a control command that is based on the difference between the target pan angle and the current pan angle and the difference between the target tilt angle and the current tilt angle. The CPU 101 then transmits the generated control command to the drive unit 109 via the drive I/F 108. In addition, when changing an item whose change does not involve the operation of the drive unit 109, the CPU 101 rewrites the configured value stored in the ROM 103 to the designated value, for example.

In step S812, the CPU 101 of the camera 100 obtains the current values of the items of the image capture configurations for which change started in step S811, from the drive unit 109 or the ROM 103. In step S813, the CPU 101 then determines whether or not the change of the image capture configurations has been completed. For example, the CPU 101 determines whether or not the current pan and tilt angles obtained from the drive unit 109 in step S812 have reached the target pan and tilt angles designated in the command. In a case of changing a plurality of items, the CPU 101 determines whether or not change of all of the items has been completed. The CPU 101 executes step S814 if it is determined that change of all the image capture configurations instructed by the received command has been completed, otherwise repeatedly executes steps S812 and S813.

In step S814, the CPU 101 of the camera 100 transmits a “change completion notification of image capture configurations” to an entity that has transmitted the command (the controller 400), via the network I/F 105. When this change completion notification is detected, the CPU 401 determines in step S801 in FIG. 7A that change of the image capture configurations of the camera 100 has been completed.

As described above, completion of change of image capture configurations may be determined by the controller 400 obtaining the current values of the image capture configurations from the camera, or the camera that has received a command may determine that change of the image capture configurations that is based on the command has been completed and notify the controller 400 of the completion.

According to the first embodiment, in the multi-camera system, image capture configurations of a plurality of cameras can be collectively changed, and thus the user's effort can be significantly reduced, particularly when the number of cameras is large. In addition, collective change can be performed by a method that ensures that there is at least one camera capturing a moving image in accordance with changed configurations, and thus interruption of a moving image having desired content and quality can be prevented even during execution of the collective change.

### Variations

The cameras 100 and 200 may be configured as cameras that can be remotely operated including zoom operations and are each installed on a motorized camera platform that enables remote control of the pan and tilt angles, for example. In this case, the CPU 401 of the controller 400 transmits a command for controlling the capture direction to the motorized camera platforms, and transmits a command for controlling the zoom value to the camera. The motorized camera platform includes a CPU and configurations equivalent to the drive I/F 108, the drive unit 109, and the network I/F 105 of the camera 100, and controls the pan and tilt angles of the camera platform in accordance with a command received from the controller 400. In addition, the CPU transmits the current pan and tilt angles in response to a command from the controller 400, and notifies the controller 400 of completion of an operation performed in response to the command.

### Second Embodiment

Next, a second embodiment will be described. A multi-camera system according to the second embodiment includes a camera operated by the user and a camera that automatically tracks a subject and captures an image of the subject. In the present embodiment, the controller 400, which serves as a capture control apparatus, is capable of collectively changing image capture configurations of a plurality of cameras that automatically track a subject and capture an image of the subject in accordance with the state of the camera operated by the user.

### Overview of Multi-Camera System

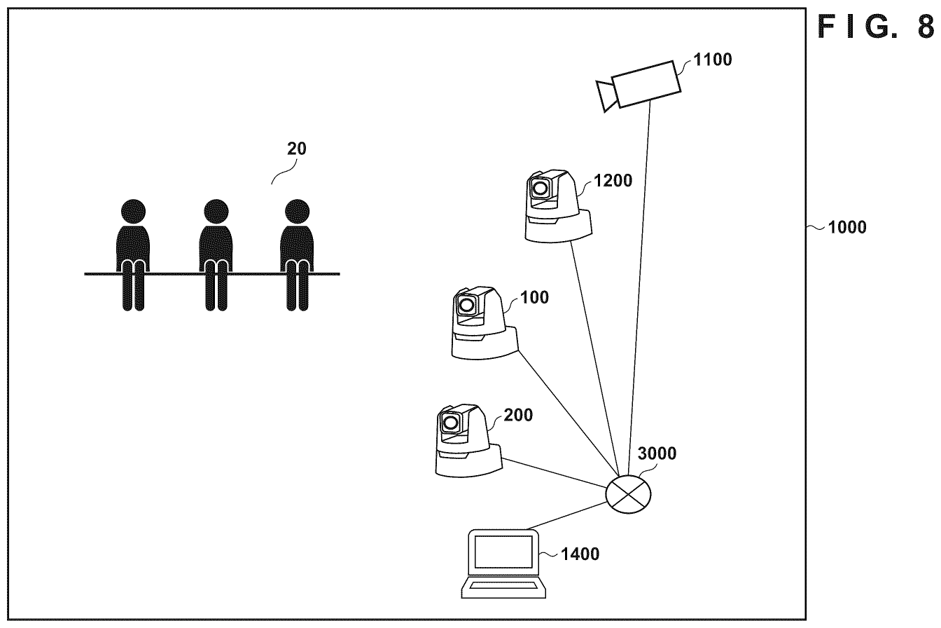

FIG. 8 is a diagram showing an overall configuration of a multi-camera system 1000 according to the present embodiment. The same reference numerals as those in FIG. 1 are assigned to the same constituent elements as those of the first embodiment, and a description thereof is omitted. The multi-camera system 1000 includes a plurality of cameras 100, 200, 1100, and 1200 and a controller 1400.

The cameras 100, 200, 1100, and 1200 are image capture apparatuses for capturing images of the subject 20, and the controller 1400 is a capture control apparatus that remotely controls the operations of the cameras 100, 200, 1100, and 1200. The controller 1400 and each of the cameras 100, 200, 1100, and 1200 are configured to be able to communicate with each other via the network 300. The network 300 may be a portion of the multi-camera system 1000 or may be an external network. Note that the controller 1400 and each of the cameras 100, 200, 1100, and 1200 may be directly connected to each other. In this case, the network 300 is not necessary.

The camera 1100 captures an image of an entire predetermined captured area. The capture direction and angle of view of the camera 1100 are set such that the camera 1100 captures an image of an area in which subjects 20 that are image capture targets may be present, for example, in a studio. The capture direction and angle of view of the camera 1100 are basically fixed. Therefore, a moving image captured by the camera 1100 includes all of the subjects 20 present within the captured area. To distinguish the camera 1100 from the other cameras 100, 200, and 1200 whose capture directions and angles of view are not basically fixed during image capturing, the camera 1100 will hereinafter be referred to as an “overhead camera 1100” for convenience.

The camera 1200 is a camera having a mechanism capable of performing pan, tilt, and zoom (PTZ) control for changing the capture direction and capture angle of view of the camera 1200, for example. Here, the operation of the camera 1200 is assumed to be controlled by the user. Note that the camera 1200 may also be configured such that the capture direction (pan and tilt) thereof can be controlled by mounting the camera body on a motorized camera platform. Hereinafter, the camera 1200 will be referred to as a “user-operated camera 1200”.

The controller 1400 remotely controls the cameras 100 and 200, the overhead camera 1100, and the user-operated camera 1200. Note that, in the present embodiment, the user operates the user-operated camera 1200 using the controller 1400. However, the user may operate the user-operated camera 1200 using a dedicated controller other than the controller 1400. The controller 1400 also detects a subject based on moving image signals received from the overhead camera 1100, and automatically controls the capture directions and angles of view of the cameras 100 and 200 in such a manner as to automatically track a specific subject and capture an image of the specific subject using the cameras 100 and 200, based on the detection result.

### Description of Configuration

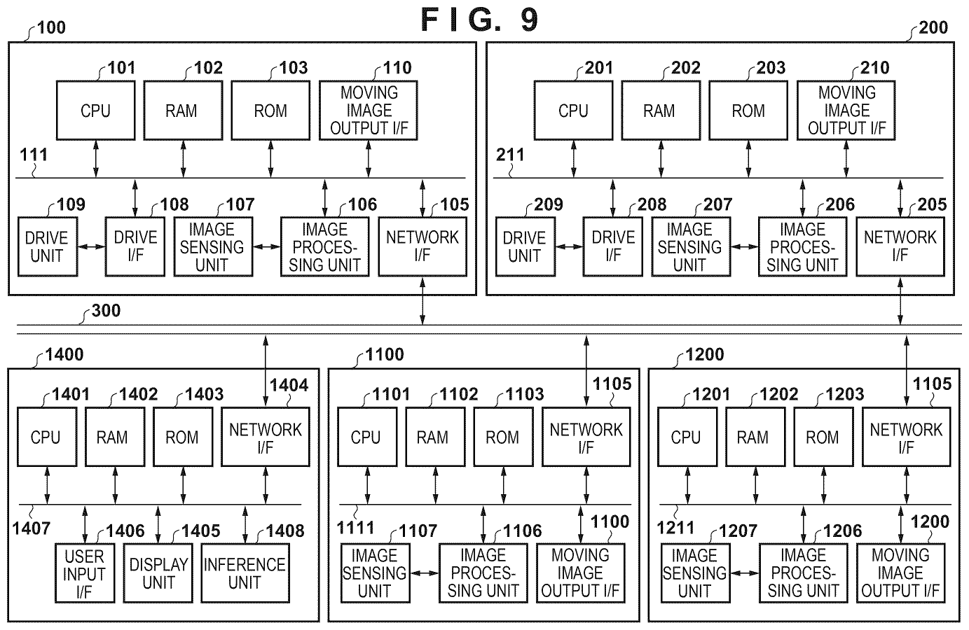

FIG. 9 is a block diagram showing configuration examples of the cameras 100, 200, 1100, and 1200, and the controller 1400. The same reference numerals as those in FIG. 2 are assigned to the same constituent elements as those of the first embodiment, and a description thereof is omitted. FIG. 9 shows only constituent elements required for describing the following operations.

The overhead camera 1100 includes a CPU 1101, a RAM 1102, a ROM 1103, a network I/F 1105, an image processing unit 1106, an image sensing unit 1107, a moving image output I/F 1110, and a system bus 1111. The functions of the components are similar to those of the constituent elements of the cameras 100 and 200 that have the same names. Note that the overhead camera 1100 may include a drive I/F and a drive unit, as with the cameras 100 and 200.

The user-operated camera 1200 includes a CPU 1201, a RAM 1202, a ROM 1203, a network I/F 1205, an image processing unit 1206, an image sensing unit 1207, a drive I/F 1208, a drive unit 1209, a moving image output I/F 1210, and a system bus 1211. The functions of the components are similar to those of the constituent elements of the cameras 100 and 200 that have the same names.

The controller 1400 includes a CPU 1401, a RAM 1402, a ROM 1403, a network I/F 1404, a display unit 1405, a user input I/F 1406, and a system bus 1407. Configurations of the components are similar to those of constituent elements of the controller 400 that have the same names. The controller 1400 further includes an inference unit 1408.

On a moving image from the overhead camera 1100, the inference unit 1408 performs processing for detecting a subject region using a trained machine learning model. The inference unit 1408 can be realized by using a hardware circuit capable of executing computation of a machine learning model at a high speed, for example. Examples of such a hardware circuit include a graphics processing unit (GPU) and a neural network processing unit (NPU). Alternatively, the inference unit 1408 may be realized using a reconfigurable logic circuit such as a field-programmable gate array (FPGA). In addition, the function of the inference unit 1408 may be realized by the CPU 1401 executing a program.

The machine learning model may be a convolutional neural network (CNN) trained based on a type of subject to be detected. Here, the inference unit 1408 detects a human body region or a human face region in an input image as a subject region. The inference unit 1408 also outputs the position, size, and detection reliability of a rectangular region in which each subject region that has been detected is inscribed. Note that a plurality of types of machine learning models may be used to execute processing for detecting different types of subject regions, on the same input image. Note that the inference unit 1408 may also perform subject region detection processing using a known method that does not use a machine learning model. The inference unit 1408 can detect subject regions using a method that uses a local feature amount such as SIFT or SURF, or a method that uses pattern matching, for example.

### Description of Operations

Next, the operation of the multi-camera system 1000 will be described.

In the multi-camera system 1000, the capture direction and the capture angle of view of the user-operated camera 1200 are operated by the user (the camera operator or the user of the controller 1400). On the other hand, the capture directions and the angles of view of the cameras 100 and 200 are automatically controlled by the controller 1400. Here, the controller 1400 controls the capture directions and angles of view of the cameras 100 and 200 such that a specific subject is tracked and images thereof are captured. In addition, configurations (hereinafter referred to as a “role”) of how a capture direction and angle of view are to be automatically controlled are set for each of the cameras 100 and 200 in advance. The controller 1400 determines the state of the user-operated camera 1200 and, in accordance with the state of the user-operated camera 1200 and the roles set for the respective cameras 100 and 200, automatically controls the capture directions and angles of view of the cameras 100 and 200.

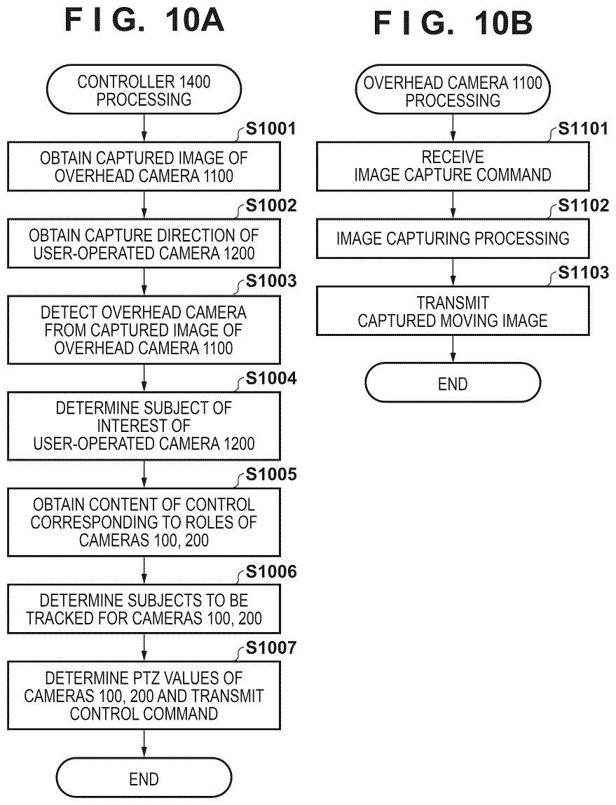

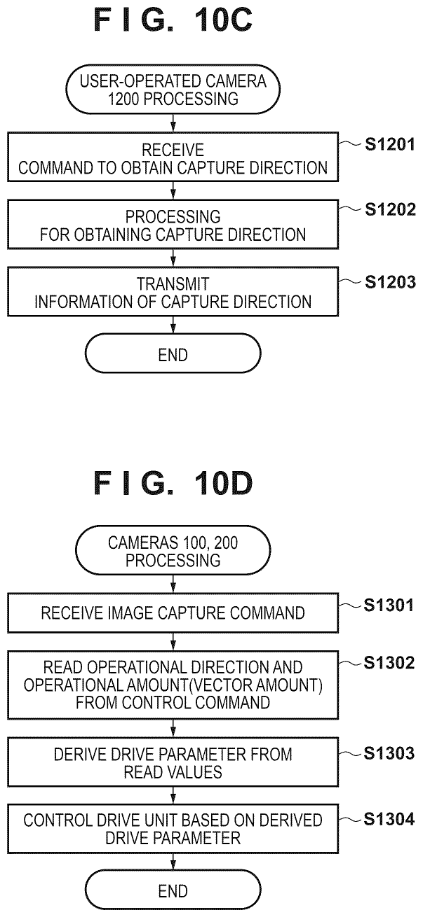

Operations of the apparatuses will be described below. FIGS. 10A to 10D are flowcharts related to the operations of the controller 1400, the overhead camera 1100, the user-operated camera 1200, and the cameras 100 and 200, respectively.

In the following description, it is assumed that the three-dimensional coordinate values of the viewpoint position and the capture direction (optical-axis direction) of the overhead camera 1100 are known to the controller 1400. In addition, known position information, such as the three-dimensional coordinate values of the viewpoint positions of the cameras 100 and 200 and the user-operated camera 1200, and the coordinate values of markers disposed in the captured area, is stored in advance in the ROM 403 as predefined position information REF_POSI.

### Operations of Controller 1400

In step S1001, the CPU 1401 of the controller 1400 transmits an image capture instruction command to the overhead camera 1100 via the network I/F 1404 in accordance with a predetermined protocol. In response to this command, supply of moving image signals (moving-image data) IMG from the overhead camera 1100 via the network I/F 1404 is started. After starting to store the received moving image signals in the RAM 102, the CPU 1401 executes step S1002.

In step S1002, the CPU 1401 obtains information ANGLE indicating a capture direction from the user-operated camera 1200. Specifically, the CPU 1401 transmits a command to obtain a capture direction, to the user-operated camera 1200 via the network I/F 1404 in accordance with a predetermined protocol. In response to the command to obtain a capture direction, the CPU 1201 of the user-operated camera 1200 transmits, to the controller 1400, the information ANGLE indicating the current capture direction of the user-operated camera 1200. The information ANGLE may be, for example, the pan and tilt angles of the drive unit 1209. The CPU 1401 stores the obtained information ANGLE in the RAM 1402.

In step S1003, the CPU 1401 executes the following processing using the inference unit 1408:
(1) Apply subject region detection processing to an input frame image and store detection results;
(2) For each detected subject region, convert the coordinates of position information (image coordinates);
(3) For each detected subject region, apply identification processing and specify identification information (in a case of a new subject, add information for identification processing); and
(4) For each detected subject region, store identification information ID[n] and position information POSITION[n] in association

The processing of step S1003 will be described below in order.

(1) First, the CPU 1401 reads out, from the RAM 1402, one frame of a moving image received from the overhead camera 1100, and inputs the frame to the inference unit 1408. Next, the inference unit 1408 inputs the frame image to the machine learning model and detects subject regions. The inference unit 1408 stores, in the RAM 1402, the position and size of each detected subject region output by the machine learning model, and the detection reliability, as detection results. The position and size of a subject region may be any information that can specify the position and size of a rectangular region in which the subject region is inscribed. Here, the central coordinates of the lower side and the width and height of the rectangular region are used as the position and size of the subject region.

In addition, the inference unit 1408 stores the detection results of the first frame image in the RAM 1402 in association with the identification information ID[n] of subjects. Here, n is an integer representing the subject number, taking a value from 1 to the total number of detected subject regions. Furthermore, the inference unit 1408 stores the subject regions detected from the first frame image in the RAM 1402 in association with the identification information ID[n] of the subjects, as templates for identifying the individual subjects. If template matching is not used for subject identification, templates do not need to be stored.

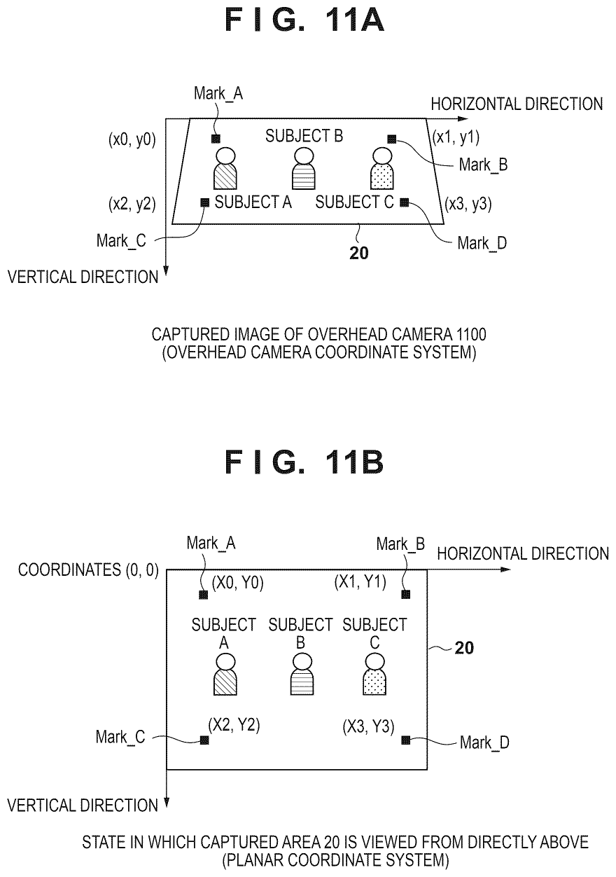

FIG. 11A shows an example of results of subject detection processing performed by the inference unit 1408 on a moving image from the overhead camera 1100. Here, the regions of person subjects A to C present in a captured area 2000 are detected, and the coordinates of the center of the lower side of the rectangular region in which each of the subject regions is inscribed (foot coordinates) are output as the position of the subject region.

Note that, in a case where, for coordinate conversion to be described below, markers Mark are disposed at known positions within the captured area 2000, for example, as shown in FIG. 11B, the CPU 1401 detects the images of the markers included in a frame image (FIG. 11A) and stores the positions thereof in the RAM 102. A configuration may also be adopted in which detection of marker images is also executed by the inference unit 1408. Detection of marker images can be performed by any known method, such as pattern matching using templates of markers. Marker images may also be detected using a machine learning model for marker detection stored in advance.

(2) Next, coordinate conversion that is executed by the inference unit 1408 will be described. FIG. 11A schematically shows a moving image from the overhead camera 1100, and FIG. 11B schematically shows a state of the captured area 2000 as viewed from directly above the center thereof. The inference unit 1408 converts the position of each subject region in the coordinate system of the overhead camera into values in a coordinate system (planar coordinate system) when the captured area 2000 is viewed from directly above the center thereof.

Here, coordinate conversion into values in the plane coordinate system is performed, since it is convenient when calculating a pan value (movement angle on the horizontal plane or amount of change of the pan angle) for the camera 100 or the camera 200 to capture an image of a specific subject. Note that, here, it is assumed that the cameras 100 and 200 are installed such that the drive unit 109 and the drive unit 209 perform a pan operation on a horizontal plane parallel to the floor of the captured area 2000.

Coordinate conversion can be executed using various methods, but, here, markers are disposed at a plurality of known positions on the floor of the captured area 2000, and based on marker positions in a moving image obtained from the overhead camera 1100, coordinate conversion is performed from the overhead camera coordinate system into the plane coordinate system. Note that coordinate conversion may be performed without using markers, but using the viewpoint position and capture direction of the overhead camera 1100, for example.

Coordinate conversion can be executed using a homography conversion matrix H in accordance with Expression 5 below.

$$( \begin{matrix}X \\ Y \\ W\end{matrix} ) = H ( \begin{matrix}x \\ y \\ 1\end{matrix} ) \qquad ( 5 )$$

In Expression 5, x and y on the right side are horizontal and vertical coordinates in the overhead camera coordinate system, and X and Y on the left side are horizontal and vertical coordinates in the plane coordinate system.

The homography conversion matrix H can be calculated by substituting the coordinates of four markers detected from a moving image and the (known) coordinates of the four markers disposed in the captured area 2000 into Expression 5 and solving the simultaneous equation. If the positional relation between the captured area 2000 and the overhead camera 1100 is fixed, the homography conversion matrix H can be calculated in advance when capturing a test image, and saved in the ROM 1403, for example.

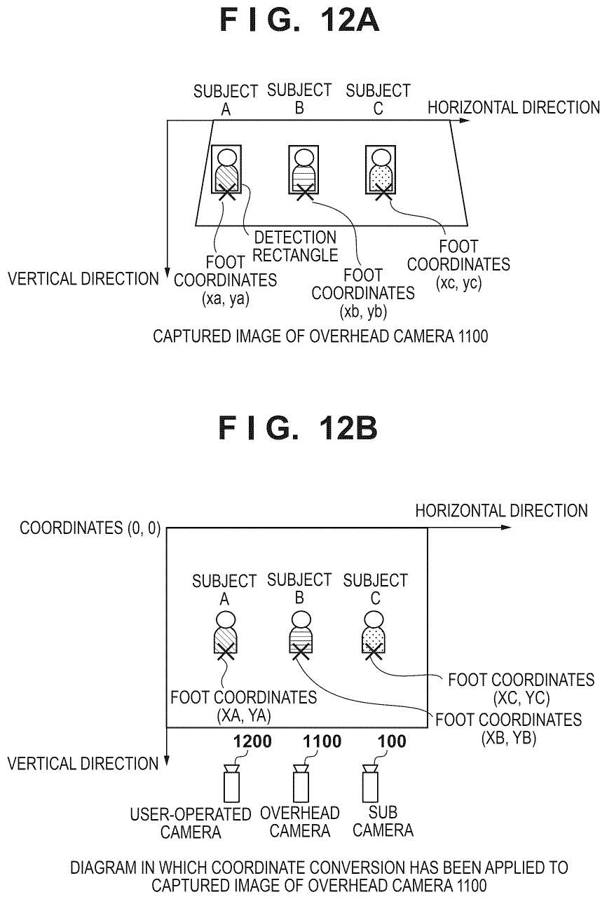

The CPU 1401 sequentially reads out the positions of the subject regions from the RAM 1402 and converts the positions into values in the plane coordinate system. FIG. 12B schematically shows a state where the foot coordinates (x, y) of each subject region, which has been detected in a moving image captured by the overhead camera 1100 and shown in FIG. 12A, have been converted into coordinate values (X, Y) in the plane coordinate system using Expression 1 and the homography conversion matrix H stored in the ROM 103. The CPU 1401 stores the foot coordinate subjected to conversion in the RAM 1402 as POSITION[n].

(3) Next, an operation in which the inference unit 1408 specifies the identification information ID[n] of subjects will be described. Here, the subjects are identified using template matching. Identification of subjects is performed on processing results of subject detection performed from the second time onward. In the processing result performed the first time, it suffices for identification information ID[n] to be newly allocated to subject regions.

The inference unit 1408 specifies the identification information ID[n] of a detected subject region by template matching using templates stored in the RAM 1402. Accordingly, the subject within the captured area is identified. The inference unit 1408 calculates, for example, an evaluation value representing the correlation between each template and a detected subject region. The inference unit 1408 then specifies, as the identification information ID[n] of the subject region, the identification information ID[n] corresponding to a template that has a certain level of correlation or more and has the highest correlation. A known value such as the sum of absolute differences between pixel values can be used as the evaluation value.

Note that, the inference unit 1408 allocates new identification information ID[n] to a subject region that does not have a certain level of correlation or more with any of the templates, and adds an image of the subject region as a template.

In addition, the inference unit 1408 may update an existing template using a subject region detected in the most recent frame image, or delete a template with which a subject region having a certain level of correlation or more has not been present for a certain period of time. Furthermore, the inference unit 1408 may store, in the ROM 103, a template corresponding to identification information ID[n] that frequently appears.

Note that a subject may be identified by a method other than template matching. For example, identification information ID[n] of subject regions, which are closest in terms of at least one of the previously detected position and size, may be specified as the same. In addition, a configuration may be adopted in which a position in the current frame image is estimated, using a Kalman filter or the like, from positions in results of detection performed a plurality of times in the past, the positions being associated with the same identification information, and the same identification information ID is specified for a subject region closest to the estimated position. These methods may be used in combination. By not using template matching, the identification accuracy of different subjects having similar appearances can be improved.

(4) The inference unit 1408 stores, in the RAM 1402, the specified identification information ID[n] in association with the position POSITION[n] of a corresponding subject region (in the plane coordinate system).

Note that processing other than subject detection out of the processing of (1) to (4) may be executed by the CPU 1401 in place of the inference unit 1408.

Here, the identification information ID[n] and the position POSITION[n] related to a subject within the captured area 2000 are obtained using a moving image from the overhead camera 1100. However, moving images from the cameras 100 and 200 may be used. In this case, the CPU 1401 executes the operation shown in the flowchart in FIG. 10A, for each of the cameras 100 and 200. The position of a subject region is output as values in the coordinate systems of the cameras 100 and 200. In this manner, the overhead camera 1100 is not essential, but it is conceivable that detection accuracy of a subject is more favorable when the overhead camera 1100 is used.

Returning to the description of FIG. 6A, in step S1004, the CPU 1401 determines a subject of interest, which is a subject to be tracked by the user-operated camera 1200. The CPU 1401 can determine a subject of interest of the user-operated camera 1200, from among the subjects detected in step S1003, based on the capture direction of the user-operated camera 1200 obtained in step S1002. The CPU 1401 stores, in the RAM 1402, the identification information ID[n] corresponding to the subject region determined as the subject of interest of the user-operated camera 1200, as identification information MAIN_SUBJECT of the subject of interest.

For example, the CPU 1401 may determine a subject closest to the capture direction of the user-operated camera 1200 in the plane coordinate system as a subject of interest of the user-operated camera 1200. Note that, when there are a plurality of subjects whose distance from the capture direction of the user-operated camera 1200 is less than or equal to a threshold, the user may select a subject of interest from among the subjects.

When the user selects a subject of interest, the CPU 1401 causes the display unit 1405 or an external display device to display a frame image to which the subject detection processing was applied in step S1003, together with an indicator indicating the capture direction and indicators indicating subject regions that are candidates for a subject of interest. The indicators of the subject regions may be, for example, rectangular frames indicating the outer edges of the subject regions such as those shown in FIG. 12A, but may be other types of indicators. In addition, the CPU 1401 may also cause the display unit 1405 to display a message or the like prompting the user to select a subject of interest in the image.

The user can select a subject region corresponding to a desired subject of interest by performing an operation on the user input I/F 1406 (input device). The selection method is not particularly limited, but may be an operation of designating a desired subject region by performing an operation on a mouse and keyboard.

When the user operation of designating a subject region is detected, the CPU 1401 stores the identification information ID[n] corresponding to the designated subject region, in the RAM 1402 as the identification information MAIN_SUBJECT of the subject of interest.

Next, in step S1005, the CPU 1401 obtains roles (role configuration information) corresponding to the cameras 100 and 200. The role configuration information is information in which identification information of the cameras 100 and 200 is associated with information indicating the roles assigned to the cameras.

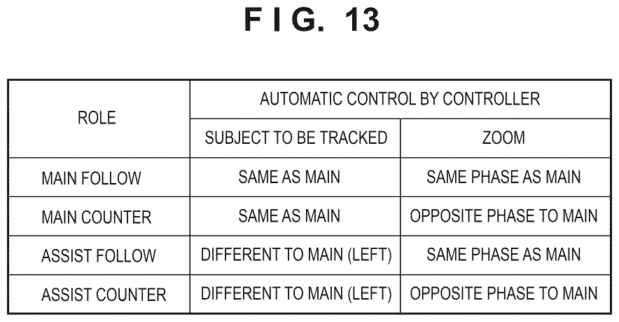

FIG. 13 shows an example of types of roles that can be assigned to the cameras 100 and 200 and control content associated with the roles. The control content for the roles can be stored in the ROM 1403, for example, in a table format shown in FIG. 13.

Here, one of “main follow”, “main counter”, “assist follow”, and “assist counter” can be set as a role. Note that different roles can be assigned to the cameras 100 and 200.

In a camera whose role is “main follow”, the controller 1400 (CPU 1401) sets the same subject to be tracked as that of the user-operated camera 1200, and when a zoom operation is performed on the user-operated camera 1200, performs zoom control of the same phase.

Here, “same phase” indicates that the zoom directions are the same (telephoto direction or wide-angle direction), that is, the directions of change in the angle of view are the same. On the other hand, “opposite phase” indicates that the zoom directions are opposite (telephoto direction and wide-angle direction), that is, the directions of change in the angle of view are opposite. Note that, even when the zoom direction is in the same phase, the angle of view does not need to be equal to that of the user-operated camera 1200, and in both the same phase and opposite phase, the degree of change in zoom (such as change speed or rate) does not need to be equal to that of the user-operated camera 1200.

For a camera whose role is “main counter”, the controller 1400 (CPU 1401) sets the same subject to be tracked as that of the user-operated camera 1200, and, when a zoom operation is performed on the user-operated camera 1200, performs zoom control in the opposite phase.

For a camera whose role is “assist follow”, the controller 1400 (CPU 1401) sets a different subject to be tracked from the subject to be tracked by the user-operated camera 1200, and, when a zoom operation is performed on the user-operated camera 1200, performs zoom control in the same phase.

For a camera whose role is “assist counter”, the controller 1400 (CPU 1401) sets a different subject to be tracked from the subject to be tracked by the user-operated camera 1200. In addition, when a zoom operation is performed on the user-operated camera 1200, the controller 1400 performs zoom control in the opposite phase.

Here, a subject located on the left, among the subjects in the image other than the subject of interest of the user-operated camera 1200, is set as a subject to be tracked by the cameras whose roles are “assist follow” and “assist counter”. Note that a subject to be tracked by a camera may be set in accordance with other conditions. For example, a subject on the left, upper, right, or lower side, among the subjects in the image other than the subject of interest of the user-operated camera 1200, may be set as a subject to be tracked by the camera 100 or 200. Alternatively, among the subjects other than the subject of interest of the user-operated camera 1200, the subject located closest to or farthest from a camera may be set as a subject to be tracked by the camera.

In the multi-camera system 1000 according to the present embodiment, when the subject of interest of the user-operated camera 1200 changes, the CPU 1401 determines a subject that is to be newly tracked by each of the cameras 100 and 200, based on the role assigned thereto. The image capture configurations of the cameras 100 and 200 are then collectively changed in order to track the determined subject.

As described above, roles assigned to the cameras 100 and 200 define a subject that is tracked and how to automatically control the size of the subject that is tracked in a moving image (frame image). Note that content defined by a role is not limited thereto. For example, each role may also include composition configurations for designating a position of a subject being tracked that is to be maintained in a moving image. In addition, configurations and the like relating to the responsiveness of the capture direction and zoom value during tracking (the sensitivity of control of the cameras 100 and 200 to changes in the capture direction and zoom of the user-operated camera 1200) may also be included. If each role includes these configurations, the user can adjust more detailed configurations for tracking image capture. In a case where these configurations are included, configurations related to composition, configurations related to drive speeds of a pan angle, a tilt angle, and a zoom value during tracking image capture, and acceleration rates of the drive speeds can be added in the table shown in FIG. 13.

In step S1007, the CPU 1401 determines a subject to be tracked and captured by the cameras 100 and 200, based on the subject of interest of the user-operated camera 1200 determined in step S1004 and the roles assigned to the cameras 100 and 200.

For example, the CPU 1401 determines the subject of interest of the user-operated camera 1200, as a subject to be tracked by cameras assigned the roles “main follow” and “main counter”. Therefore, the CPU 1401 sets the identification information MAIN_SUBJECT of the subject of interest determined in step S1003, as identification information SUBJECT_ID of a subject to be tracked by cameras assigned the roles “main follow” and “main counter”.

In addition, the CPU 1401 determines a subject located to the left of the subject of interest of the user-operated camera 1200, as a subject to be tracked by cameras assigned the roles “assist follow” and “assist counter”. In this case, the CPU 1401 detects the leftmost subject region from among the subject regions detected in step S1003 other than the subject of interest of the user-operated camera 1200. The CPU 1401 then sets the identification information ID[n] corresponding to the detected subject region, as the identification information SUBJECT_ID of the subject to be tracked by the cameras assigned the roles “assist follow” and “assist counter”.

The CPU 1401 writes the identification information SUBJECT_ID of the determined subject to be tracked, to the RAM 1402. In a case where subjects to be tracked by the camera 100 and 200 may be different, the CPU 1401 stores the identification information SUBJECT_ID of the subject to be tracked in association with identification information of the cameras 100 and 200. Note that, when the subject to be tracked is changed, the CPU 101 holds information regarding the old subject to be tracked in the RAM 1402 without deleting it.

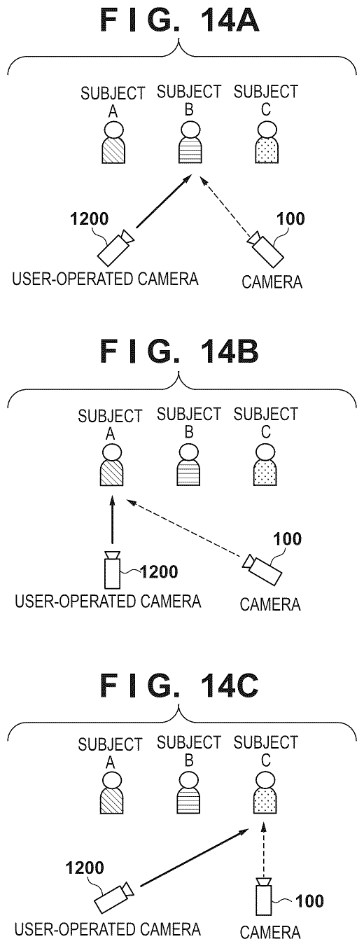

Here, the operation in a case where the role assigned to the camera 100 is “main follow” will be described with reference to FIGS. 14A to 14C. The controller 1400 performs control such that the camera 100 assigned the role “main follow” tracks the subject of interest of the user-operated camera 1200.

Therefore, when the subject of interest of the user-operated camera 1200 is determined as a subject B as shown in FIG. 14A, the CPU 1401 determines the subject B as a subject to be tracked by the camera 100. Thereafter, when it is determined that the subject of interest of the user-operated camera 1200 has been changed to a subject A as shown in FIG. 14B, the CPU 1401 changes the subject to be tracked by the camera 100 to the subject A. Similarly, when it is determined that the subject of interest of the user-operated camera 1200 has been changed to a subject C as shown in FIG. 14C, the CPU 1401 changes the subject to be tracked by the camera 100 to the subject C.

Next, in step S1008, the CPU 1401 calculates amounts of change in the pan and tilt angles required for the cameras 100 and 200 to track the subject to be tracked determined in step S1007 and capture images thereof. In addition, the CPU 1401 calculates zoom values of the cameras 100 and 200 in correspondence with a change in the angle of view of the user-operated camera 1200.

Although a calculation method for the camera 100 will be described below, similar calculation is performed for the camera 200.

Note that, here, for the cameras 100 and 200, the following information is stored in the ROM 1403 in advance as defined position information REF_POSI;
three-dimensional coordinates of installation positions (values in the plane coordinate system);
capture directions corresponding to initial values of pan and tilt angles of the drive units; and
controllable ranges of pan and tilt angles.

The CPU 1401 reads out, from the RAM 1402, position information POSITION_OH corresponding to the identification information SUBJECT_ID of the subject to be tracked by the camera 100. Then, the CPU 1401 first determines a pan angle based on the position information POSITION_OH and the installation position of the camera 100.

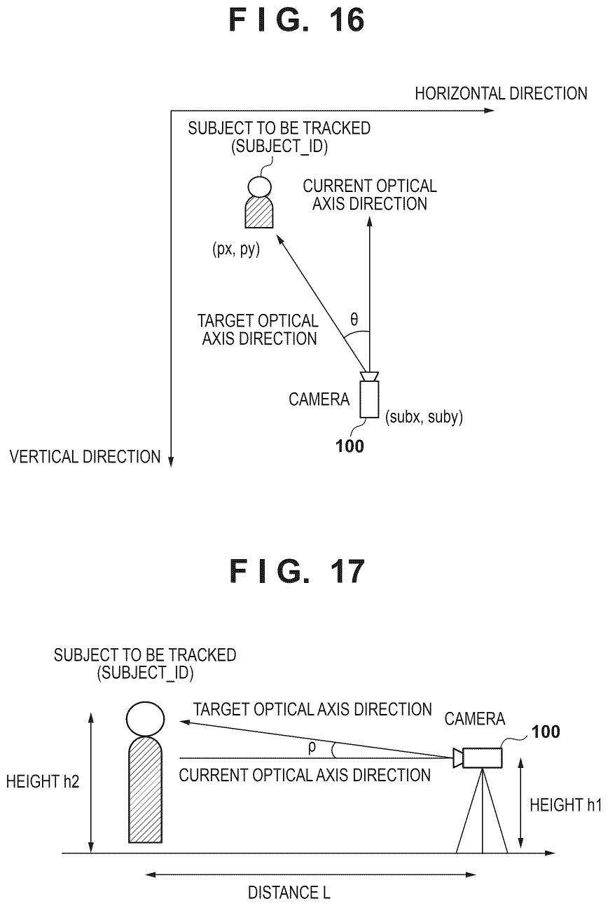

FIG. 16 is a diagram showing an example of positional relation between the camera 100 and a subject to be tracked by the camera 100 in the plane coordinate system. Here, a pan angle θ for directing the optical axis direction of the camera 100 to the subject position is determined. The CPU 1401 calculates the pan angle θ using Expression 6 below.

$$θ = {tan}^{- 1} \frac{px - subx}{py - suby} ( rad ) \qquad ( 6 )$$

px and py in Expression 6 respectively indicate a horizontal coordinate and a vertical coordinate of the position information POSITION_OH corresponding to the identification information SUBJECT_ID of the subject to be tracked. In addition, subx and suby respectively indicate a horizontal coordinate and a vertical coordinate of the installation position of the camera 100. Here, it is assumed that the current pan angle takes an initial value of 0° and the optical axis direction is the vertical direction (Y axis direction). When the current optical axis direction is not the vertical direction, it suffices for an angle obtained using Expression 2 to reflect the angle difference between the current optical axis direction and the vertical direction. In addition, the panning direction is the counterclockwise direction if subx>px, and the clockwise direction if subx<px.

Next, a method for determining a tilt angle will be described with reference to FIG. 17. FIG. 17 shows a state where the camera 100 and a subject to be tracked by the camera 100 are viewed from the side. It is assumed that the current optical axis of the camera 100 is in the horizontal direction and the camera 100 has a height h1, and that the face of the subject to be tracked, to which the optical axis is directed, has a height h2. The angle difference in the height direction (tilt angle) between the current optical axis direction and a target optical axis direction is denoted by ρ. The CPU 1401 calculates a tilt angle ρ using Expressions 7 and 8 below.

$$L = \sqrt{{( p x - s u b x )}^{2} + {( p y - s u b y )}^{2}} \qquad ( 7 )$$

$$ρ = {tan}^{- 1} \frac{h 2 - h 1}{L} ( rad ) \qquad ( 8 )$$

Coordinate values used in Expression 8 are the same as coordinate values used in Expression 7. h1 and h2 are input to the capture control application in advance, and are stored in the RAM 1402. In this case, identification number associated with h2 of each subject and identification number allocated in subject detection processing are set to the same number. Alternatively, a value measured in real time using a sensor (not illustrated) may be used as h2.

Here, it is assumed that the current tilt angle takes an initial value of 0°, and the optical axis direction is the horizontal direction (with a constant height). When the current optical axis direction is not the horizontal direction, it suffices for the angle obtained using Expression 8 to reflect the angle difference between the current optical axis direction and the horizontal direction. In addition, the tilt direction is a downward direction when h1>h2, and an upward direction when h1<h2.

The CPU 1401 cyclically communicates with the camera 100 to obtain the current optical axis direction (the pan and tilt angles of the drive unit) and stores the current optical axis direction in the RAM 1402. Note that the communication cycle can be less than or equal to the reciprocal of the frame rate, for example. Alternatively, the CPU 1401 may hold, in the RAM 1402, the total value of the pan and tilt angles of the camera 100 controlled from the initial state and use these values as the current optical axis direction.

In this manner, the CPU 1401 calculates the amounts of change in the pan angle and tilt angle of the camera 100, and stores the amounts in the RAM 1402.

The amounts of change in the pan angle and tilt angle may also be used as angular velocities for rotating the camera 100 in the direction of the subject to be tracked. For example, the CPU 1401 obtains the current pan angle and tilt angle from the camera 100. The CPU 1401 then obtains a pan angular velocity proportional to the difference between the pan angle θ read from the RAM 1402 and the current pan angle. In addition, the CPU 1401 obtains a tilt angular velocity proportional to the difference between the tilt angle ρ read from the RAM 1402 and the current tilt angle. The CPU 1401 stores the angular velocities calculated in this manner in the RAM 1402.

Note that, instead of a moving image from the overhead camera 1100, a moving image from the camera 100 may be used to calculate amounts of change in the pan angle and tilt angle. In this case, the CPU 1401 may calculate an amount of change in the pan angle from the difference in the horizontal direction between the current optical axis direction and the direction of the subject to be tracked in the coordinate system of the camera 100 and calculate an amount of change in the tilt angle from the difference in the vertical direction. In addition, an image capture system may be adopted in which the capture direction for tracking and capturing a subject to be tracked is changed in only one of the pan direction and the tilt direction, and in such an image capture system, an amount of change in only one of the pan angle and the tilt angle may be calculated.

Next, an operation of calculating a zoom value performed by the CPU 1401 will be described. The CPU 1401 cyclically obtains information MAIN_ZOOM indicating the angle of view of the user-operated camera 1200 and stores it in the RAM 1402. When the information MAIN_ZOOM changes, the CPU 1401 calculates a zoom value Z_VALUE for the camera 100 in accordance with control content CAMERA ROLE corresponding to the role assigned to the camera 100.

Note that the CPU 1401 can determine a zoom operation of the user-operated camera 1200 and a phase thereof, for example, by detecting a change in the angle of view in a moving image from the user-operated camera 1200. For example, change in the angle of view may be detected based on change over time in the size of a subject region, the distance between subject regions, and the like.

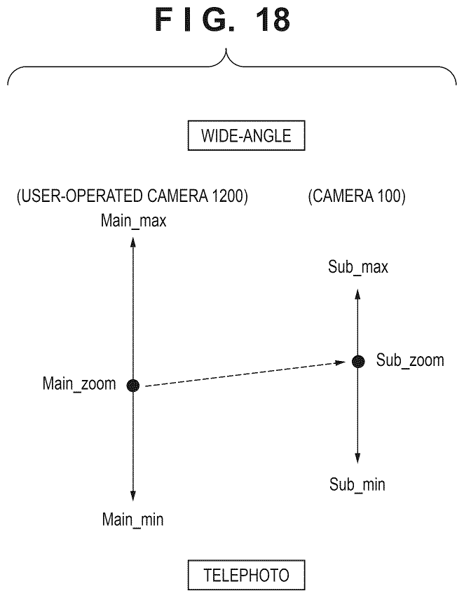

FIG. 18 illustrates an example of mapping of zoom values between the user-operated camera 1200 and the camera 100. Here, it is assumed that the user-operated camera 1200 and the camera 100 optically change the angles of view thereof (the imaging optical systems have a zoom function). However, a similar function may be realized by digital zoom using the image processing unit 106 and the image processing unit 1206.

Note that a zoom value is a parameter that takes a value corresponding to the angle of view, and, in the present embodiment, the smaller (narrower) the angle of view is, the smaller the zoom value becomes, and a zoom value on the telephoto side is smaller than a zoom value on the wide-angle side. The camera 100 and the user-operated camera 1200 can control the imaging optical systems thereof to have an angle of view corresponding to a zoom value by transmitting a command that designates the zoom value. That is, a zoom value is information related to an angle of view and information indicating a zoom state. A zoom value may be, for example, a focal length (mm) of an imaging optical system that corresponds to an image sensor having 35 mm full size, and, in this case, a zoom value on the telephoto side is larger than a zoom value on the wide-angle side.

In FIG. 18, the range of zoom value MAIN_ZOOM of the user-operated camera 1200 is main_min to main_max. In addition, the zoom range of the camera 100 is sub_min to sub_max. main_min and sub_min respectively represent zoom values corresponding to the telephoto ends of the user-operated camera 1200 and the camera 100, and main_max and sub_max respectively represent zoom values corresponding to the wide-angle ends of the user-operated camera 1200 and the camera 100. FIG. 18 shows an example where the range of zoom value of the user-operated camera 1200 is larger than the range of zoom value of the camera 100, at both the telephoto end and the wide-angle end.

For example, when performing control so as to set a zoom value SUB_ZOOM of the camera 100 to the same phase as the zoom value MAIN_ZOOM of the user-operated camera 1200, the CPU 1401 calculates SUB_ZOOM corresponding to the current MAIN_ZOOM using Expression 9 below.

$$SUB\_ZOOM = \frac{MAIN\_ZOOM - main\_min}{main\_max - main\_min} \times ( sub\_max - sub\_min ) \qquad ( 9 )$$

Returning to FIG. 10A, in step S1009, the CPU 1401 reads out, from the RAM 1402, the amounts of change in the pan angle and tilt angle calculated in step S1008, and the zoom value. The CPU 1401 then generates a control command PT_VALUE instructing the camera 100 to change the pan angle and tilt angle in correspondence with these amounts of change. In addition, the CPU 1401 generates a control command Z_VALUE instructing the camera 100 to change the angle of view in correspondence with the zoom value. The format of the control commands is defined in advance. The CPU 1401 stores the generated control commands PT_VALUE and Z_VALUE in the RAM 1402. Note that, in a case where there is no need to generate a control command such as where a subject to be tracked is stationary, or where the angle of view of the user-operated camera 1200 does not change, step S1009 may be skipped.

Note that, here, a case has been described in which a command for instructing a change in the pan angle and tilt angle designates amounts of change from the current pan angle and tilt angle. However, a configuration may be adopted in which a command designating target values of pan angle and tilt angle in place of amounts of change is generated, and the camera calculates amounts of change.

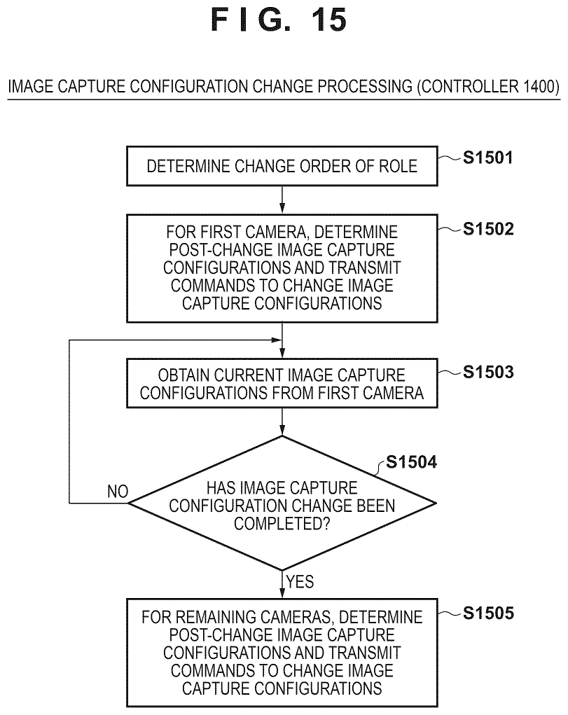

In the present embodiment, when changing the image capture configurations of both the camera 100 and 200, timings for transmitting commands are adjusted in step S1009 such that the change period of the camera 100 and the change period of the camera 200 do not overlap. This timing adjusting operation will be described with reference to FIG. 15.

FIG. 15 is a flowchart for describing details of step S1009. The CPU 1401 performs processing shown in the flowchart in FIG. 15 in parallel with processing shown in FIG. 10A.

Alternatively, a camera assigned a role for tracking and capturing a subject different from the subject of interest of the user-operated camera 1200 may precede a camera assigned a role for tracking and capturing the same subject as the subject of interest of the user-operated camera 1200. Accordingly, priority can be given to capturing an image of a subject that has not been captured by the user-operated camera 1200.

Alternatively, using the inference unit 1408 of the controller 1400, the order may be determined such that, if there is a camera that has not been able to capture an image of a subject that is to be tracked and captured (hereinafter referred to as a “subject-lost camera”), the configurations of the camera are preferentially changed. Accordingly, a camera that is highly likely to not have performed desired tracking image capture can be returned early to a state of being capable of obtaining a desired moving image.

Here, it is assumed that the CPU 1401 has determined, using a certain method, that the image capture configurations (roles) of the camera 100 and the camera 200 are to be changed in that order.

In step S1502, the CPU 1401 reads out, from the RAM 1402, the control commands PT_VALUE and Z_VALUE to change the image capture configurations of the camera 100 based on the determined role change order, and transmits the commands to the camera 100 via the network I/F 1404. At this point of time, the CPU 1401 does not transmit a command to change the image capture configurations to the camera 200.

In step S1503, the CPU 1401 obtains the current image capture configurations from the first camera 100.

In step S1504, the CPU 1401 determines whether or not change of the image capture configurations of the camera 100 has been completed. If it is determined that change of the image capture configurations has been completed, the CPU 1401 executes step S1505, otherwise executes step S1503 again.

For example, the CPU 1401 extracts the pan angle, tilt angle, and zoom value from the current image capture configurations of the camera 100 obtained in step S1503. The CPU 1401 then compares the extracted pan angle, tilt angle, and zoom value with the values designated by the control commands transmitted in step S1502 (here, target values), and can determine that change has been completed if the extracted pan angle, tilt angle, and zoom value match the values designated by the control commands. Similarly to the first embodiment again, another method can be adopted such as a method in which, even if they do not match, it is determined that change has been completed as long as the difference is less than or equal to a threshold.

Alternatively, the CPU 1401 may determine, using the inference unit 1408, whether or not a new subject to be tracked is captured in a moving image from the camera 100, and determine that change of the image capture configurations has been completed if the new subject is captured in the image.

In step S1505, the CPU 1401 reads out, from the RAM 1402, the control commands PT_VALUE and Z_VALUE for a camera other than the first camera in the determined role change order (here, the camera 200). The CPU 1401 then transmits the control commands to the camera 200 via the network I/F 1404. Note that, when there are three or more cameras assigned roles, the CPU 1401 can transmit, in step S1505, control commands to the cameras other than the first camera using various methods as described in the first embodiment. For example, the CPU 1401 may simultaneously transmit control commands to all of the cameras. Alternatively, for example, after determining that change of the image capture configurations of the second camera, which is based on the control commands, has been completed similarly to the first camera, the CPU 1401 may transmit the control commands to the remaining cameras at any timing.

As described above, also in the present embodiment, the image capture configurations can be collectively changed using a method that ensures that there is at least one camera that captures a moving image in compliance with the changed configurations, from among a plurality of cameras. Thus, similarly to the first embodiment, even while collective change is being performed, it is possible to prevent a moving image having desired content and quality from being suspended.

### Operations of Overhead Camera 1100

Next, the operation of the overhead camera 1100 will be described with reference to FIG. 10B. The operations to be described below are realized by the CPU 1101 executing a program.

When the overhead camera 1100 is turned on, the functional blocks are initialized by the CPU 1101, and the camera then enters an image capture standby state. In the image capture standby state, the CPU 1101 may start moving image capturing processing for live-view display, and output image data to be displayed, which has been generated by the image processing unit 1106, to the controller 1400 via the network I/F 1105.

In the image capture standby state, the CPU 1101 waits for a control command to be received via the network I/F 1105. Upon receiving a control command, the CPU 1101 executes an operation corresponding to the control command. Here, an operation that is performed when an image capture command is received from the controller 1400 as a control command will be described.

In step S1101, the CPU 1101 receives an image capture command from the controller 1400 via the network I/F 1105. Note that the image capture command may designate image capture parameters such as a frame rate and resolution. In addition, configurations related to processing that is applied by the image processing unit 1106 may be included.

In step S1102, in response to reception of the image capture command, the CPU 1101 starts processing for capturing a moving image to be supplied to the controller 1400. In this moving image capturing processing, a moving image of higher image quality than that captured by processing for for live-view display is captured. For example, at least one of the resolution and the image capturing frame rate of the moving image is higher than that of the moving image for live-view display. The image processing unit 1106 applies processing to an image based on configurations for a moving image to be supplied to the controller 1400. The image processing unit 1106 sequentially stores generated moving image data to the RAM 1102.

In step S1103, the CPU 1101 reads out moving image data from the RAM 1102, and transmits the moving image data to the controller 1400 via the network I/F 1105. From this point on, until a control command to stop image capturing is received, processing from image capturing to supply of moving image data is continued.

### Operation of User-Operated Camera 1200

Next, the operation of the user-operated camera 1200 will be described with reference to FIG. 10C. The operation to be described below is realized by the CPU 1201 executing a program.

When the user-operated camera 1200 is turned on, the functional blocks are initialized by the CPU 1201, and processing for capturing a moving image to be supplied to the controller 1400 is then started. The image processing unit 1206 applies processing to analog image signals obtained from the image sensing unit 1207, based on configurations for a moving image to be supplied to the controller 1400. The image processing unit 1206 sequentially stores generated moving image data in the RAM 1202. The CPU 1201 reads out the moving image data from the RAM 1202, and supplies the moving image data to the controller 1400 via the network I/F 1205.

The CPU 1201 waits for a control command to be received via the network I/F 1205 while supplying the moving image data to the controller 1400. Upon receiving a control command, the CPU 1201 executes an operation corresponding to the control command. Here, an operation that is performed when a command to obtain a capture direction is received will be described. Note that, when the control command PT_VALUE for pan/tilt or the control command Z_VALUE for zoom is received, the CPU 1201 drives the drive unit 1209 in accordance with the command.

In step S1201, the CPU 1201 receives a command to obtain a capture direction via the network I/F 1205. The CPU 1201 stores the received command to obtain a capture direction, in the RAM 1202.

In step S1202, in response to the received command to obtain a capture direction, the CPU 1201 obtains the current pan angle and tilt angle from the drive unit 1209 via the drive I/F 1208, and stores them in the RAM 1202.

In step S1203, the CPU 1201 reads out the current pan angle and tilt angle from the RAM 1202, and transmits them as the information ANGLE regarding the capture direction to the controller 1400 via the network I/F 1205.

### Operations of Cameras 100 and 200

The operations of the cameras 100 and 200 will be described with reference to FIG. 10D. Note that, here, the operation of the camera 100 will be described, but a similar operation is executed by the camera 200.

The operation to be described below is realized by the CPU 101 executing a program. When the camera 100 is turned on, the functional blocks are initialized by the CPU 101, and processing for capturing a moving image to be supplied to the controller 1400 is then started. The image processing unit 106 applies processing to analog image signals obtained from the image sensing unit 107, based on configurations for a moving image to be supplied to the controller 1400. The image processing unit 106 sequentially stores generated moving image data in the RAM 102. The CPU 101 reads out the moving image data from the RAM 102, and supplies the moving image data to the controller 1400 via the network I/F 105.

The CPU 101 waits for a control command to be received via the network I/F 105 while supplying the moving image data to the controller 1400. Upon receiving a control command, the CPU 101 executes an operation corresponding to the control command. Here, an operation that is performed when the control command PT_VALUE for pan/tilt and the control command Z_VALUE for zoom are received from the controller 1400 will be described.

In step S1301, the CPU 101 receives at least one of the control command PT_VALUE for pan/tilt and the control command Z_VALUE for zoom from the controller 1400 via the network I/F 105. The CPU 101 stores the received control command in the RAM 102.

In step S1302, the CPU 101 reads out, from the control command stored in the RAM 102, an operational amount corresponding to an operational direction, and stores the operational amount in the RAM 102. Here, in a case of the control command PT_VALUE for pan/tilt, the operational direction is the pan direction and/or the tilt direction, and the operational amount is an amount of change or a target angle. In addition, in a case of the control command Z_VALUE for zoom, the operational amount is a zoom value, and the operational direction can be specified from the zoom value, and thus there is no need to read out and store the operational direction.

In step S1303, the CPU 101 generates a drive parameter of the drive unit 109 based on the operational direction and operational amount read out in step S1302. The CPU 101 may obtain, for example, a drive parameter corresponding to a combination of the operational direction and the operational amount, using a table held in the ROM 103 in advance. Note that, in a case where the operational amount is provided as a target value (target angle or zoom value), the CPU 101 obtains a drive parameter based on the difference from the current value.

In step S1304, the CPU 101 controls the drive unit 109 via the drive I/F 108 based on the drive parameter obtained in step S1303. Accordingly, the drive unit 109 changes the capture direction of the camera 100 to the operational direction and angle designated by the control command PT_VALUE for pan/tilt. In addition, the drive unit 109 changes the angle of view of the imaging optical system to the zoom value designated by the control command Z_VALUE for zoom.

According to the second embodiment, in a multi-camera system that includes cameras that perform automatic tracking image capture, similar effect to those of the first embodiment can be realized in a case of collectively changing image capture configurations of a plurality of cameras that perform automatic tracking image capture.

Note that, in the present embodiment, a configuration has been described in which the controller 1400 collectively changes the capture directions and/or angles of view of the cameras 100 and 200 in accordance with a change in the state of the user-operated camera 1200. However, collective change may be executed in accordance with other conditions, or other image capture configurations may be collectively changed.

For example, in accordance with detection of a user instruction to collectively change the roles of the cameras 100 and 200 through the user input I/F 1406, the CPU 1401 may collectively change the image capture configurations of the cameras 100 and 200. Specifically, for example, in accordance with a menu operation of the capture control application or the like, the CPU 1401 causes a configuration screen for setting or changing the roles of the cameras to be displayed on the display unit 1405 or on an external display device. The cameras displayed on the configuration screen are cameras that are controlled automatically by the controller 1400.

The user can perform an operation on the user input I/F 1406 (input device) to select roles to be assigned to cameras (here, the cameras 100 and 200), and instruct that the selected roles are to be collectively assigned. By changing roles, it is possible to collectively change configuration items associated with the roles, such as a subject to be tracked, composition, and a zoom control method.

A method for selecting a role on the configuration screen is not particularly limited, but a configuration may be adopted in which a desired role is selected, for example, from a pull-down list by performing an operation on a mouse or a keyboard, or in which a desired role is selected by performing an operation on a button corresponding to the desired role.

Upon detecting an operation of instructing execution of configurations, such as an operation on an execution button included in the configuration screen, the CPU 1401 executes the processing described with reference to FIG. 10A, and collectively sets the roles selected for respective cameras on the configuration screen. Accordingly, also in a case where the roles of the cameras 100 and 200 are collectively changed, effects similar to those of the first embodiment can be realized.

In addition, in the present embodiment, the controller 1400 determines subjects to be tracked by the cameras 100 and 200 in accordance with the subject of interest of the user-operated camera 1200 and the roles assigned to the cameras 100 and 200. However, subjects to be tracked by the cameras 100 and 200 may be determined using another method.

For example, in response to detection, via the user input I/F 1406, of a user instruction to collectively change the subjects to be tracked by the cameras 100 and 200, the CPU 1401 may collectively change the subjects to be tracked by the cameras 100 and 200. Specifically, for example, in accordance with a menu operation on the capture control application, the CPU 1401 causes a configuration screen for setting or changing subjects to be tracked by cameras to be displayed on the display unit 1405 or an external display device. The cameras displayed on the configuration screen are cameras that are automatically controlled by the controller 1400.

The user can perform an operation on the user input I/F 1406 (input device) to select subjects to be tracked by cameras (here, the cameras 100 and 200), and instruct that the selected roles be collectively set. A method for selecting a subject to be tracked is not particularly limited, but may be similar to a method in a case where a subject of interest is selected by the user.

That is to say, the CPU 1401 displays, on the display unit 1405 or an external display device, an image on which rectangular frames indicating the outer edges of subject regions are superimposed, such as that shown in FIG. 12A. The user can select, for each camera, a subject region corresponding to a desired subject of interest by performing an operation on the user input I/F 1406 (input device). The selection method is not particularly limited, but may be an operation of designating a desired subject region by performing an operation on the mouse and keyboard.

Upon detecting an operation instructing execution of configurations, such as an operation performed on an execution button included in the configuration screen, the CPU 1401 executes the processing described with reference to FIG. 10A, and collectively sets subjects to be tracked, which have been selected for the individual cameras on the configuration screen. Note that, in step S1006, instead of determining subjects to be tracked based on the subject of interest of the user-operated camera 1200 and the roles assigned to the cameras 100 and 200, the user determines subjects to be tracked, which have been set for the cameras 100 and 200. Accordingly, also in a case of collectively changing subjects to be tracked by the cameras 100 and 200 in accordance with user configurations, effects similar to those of the first embodiment can be realized.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-207704, filed Nov. 28, 2024, which is hereby incorporated by reference herein in its entirety.

What is claimed is:

1. A capture control apparatus that controls at least one of a capture direction and an angle of view of each of a plurality of cameras that are connected to the capture control apparatus, the capture control apparatus comprising:
one or more processors that execute a program stored in a memory, wherein the program, when executed by the one or more processors, causes the one or more processors to:
in a case of collectively changing configurations of the plurality of cameras,
identify a first camera whose configuration is to be changed first, from among the plurality of cameras;
instruct the first camera to change the configuration;
determine whether or not the instructed change of the configuration of the first camera has been completed; and
instruct, in response to determining that the instructed change of the configuration of the first camera has been completed, a camera other than the first camera from among the plurality of cameras to change the configuration.

2. The capture control apparatus according to claim 1,
wherein the program further causes the one or more processors to not change the configuration of another camera until it is determined that the instructed change of the configuration of at least one camera other than the first camera from among the plurality of cameras has been completed.

3. The capture control apparatus according to claim 1,
wherein the program further causes the one or more processors to, in a case where a current configured value obtained from the first camera matches a changed configured value indicated in the instruction, determine that the instructed change of the configuration has been completed.

4. The capture control apparatus according to claim 1,
wherein the program further causes the one or more processors to, in a case where a difference between a current configured value obtained from the first camera and a changed configured value indicated in the instruction is less than or equal to a threshold, determine that the instructed change of the configuration has been completed.

5. The capture control apparatus according to claim 1,
wherein the instruction includes an instruction of a changed capture direction, and
the program further causes the one or more processors to, in a case where a current angle of view of the first camera includes the changed capture direction, determine that the instructed change of the configuration has been completed.

6. The capture control apparatus according to claim 1,
wherein the instructed change of the configuration involves mechanical driving, and
the program further causes the one or more processors to, in a case where an amount of change in a configured value obtained based on a time series of current configured values obtained from the first camera has decreased, determine that the instructed change of the configuration has been completed.

7. The capture control apparatus according to claim 1,
wherein the program further causes the one or more processors to, when a predetermined time has elapsed from when the instruction to change the configuration was given to the first camera, determine that the instructed change of the configuration has been completed.

8. The capture control apparatus according to claim 7,
wherein the predetermined time in a case where the instructed change of the configuration involves mechanical driving is longer than the predetermined time in a case where the instructed change of the configuration does not involve mechanical driving.

9. The capture control apparatus according to claim 1,
wherein the program further causes the one or more processors to, when an estimated time required for the change in the configuration has elapsed from when the instruction to change the configuration was given to the first camera, determine that the instructed change of the configuration has been completed.

10. The capture control apparatus according to claim 9,
wherein the program further causes the one or more processors to identify the first camera based on the estimated time.

11. The capture control apparatus according to claim 1,
wherein the program further causes the one or more processors to collectively change configurations of the plurality of cameras in response to a user operation of designating a combination of configured values for the plurality of cameras, from among configured values stored in the capture control apparatus.

12. The capture control apparatus according to claim 1,
wherein the capture control apparatus automatically controls at least one of the capture direction and the angle of view of each of the plurality of cameras such that a specific subject is included in the angle of view, and
the program further causes the one or more processors to collectively change, as the configurations of the plurality of cameras, at least one of the specific subject, an image capture size for capturing an image of the specific subject, and a composition for capturing an image of the specific subject, for each of the plurality of cameras.

13. The capture control apparatus according to claim 1,
wherein for each of the plurality of cameras, at least one of the capture direction and the angle of view is automatically controlled in accordance with a state of a camera other than the plurality of cameras.

14. The capture control apparatus according to claim 13,
wherein for each of the plurality of cameras, at least one of the capture direction and the angle of view is automatically controlled in accordance with a role assigned to the camera and the state of the other camera.

15. The capture control apparatus according to claim 13,
wherein the state of the other camera includes at least one of a capture direction and a subject of interest.

16. The capture control apparatus according to claim 15,
wherein the state of the other camera includes a capture direction, and the capture directions of the plurality of cameras are changed in accordance with a change in the capture direction of the other camera.

17. The capture control apparatus according to claim 15,
wherein the state of the other camera includes the subject of interest, and the capture directions of the plurality of cameras are changed such that each of the plurality of cameras tracks and captures an image of the subject of interest or a specific subject different from the subject of interest.

18. The capture control apparatus according to claim 12,
wherein the program further causes the one or more processors to, in a case where the current angle of view of the first camera includes the changed specific subject, determine that the instructed change of the configuration has been completed.

19. A multi-camera system comprising:
the capture control apparatus according to claim 1; and
a plurality of cameras connected to the capture control apparatus.

20. A capture control method for controlling at least one of a capture direction and an angle of view of each of a plurality of cameras, comprising:
in a case of collectively changing configurations of the plurality of cameras,
identifying a first camera whose configuration is to be changed first, from among the plurality of cameras;
instructing the first camera to change the configuration;
determining whether or not the instructed change of the configuration of the first camera has been completed; and
instructing, in response to determining that the instructed change of the configuration of the first camera has been completed, a camera other than the first camera from among the plurality of cameras to change the configuration.
